(19) United States
(12) Patent Application Publication
(10) Pub. No.: US 2018/0220066 A1
(43) Pub. Date: Aug. 2, 2018

(54) ELECTRONIC APPARATUS, OPERATING METHOD OF ELECTRONIC APPARATUS, AND NON-TRANSITORY COMPUTER-READABLE RECORDING MEDIUM

(71) Applicant: KYOCERA Corporation, Kyoto-shi, Kyoto (JP)

(72) Inventor: Tomohiro KITAMURA, Yokohama-shi, Kanagawa (JP)

(21) Appl. No.: 15/747,378

(22) PCT Filed: May 26, 2016
(86) PCT No.: PCT/JP2016/065525

§ 371 Date: Jan. 24, 2018

(30) Foreign Application Priority Data
Jul. 29, 2015 (JP) 2015-149682

(51) Int. Cl. H04N 5/232; G06K 9/00

(52) U.S. Cl. CPC H04N 5/23222; H04N 5/23238; G06K 2209/21; H04N 5/23293; G06K 9/00671; H04N 5/23216

(57) ABSTRACT

At least one processor detects a position of a moving object moving in a second imaging range based on an image signal from a second camera. If the at least one processor determines that there is the moving object outside a first imaging range and inside the second imaging range based on the position of the moving object, the at least one processor estimates an approach area through which the moving object passes at a time of entering the first imaging range in a periphery of the first imaging range based on the position of the moving object. A display displays first notification information for notifying the approach area on a display screen together with a first live view image captured by a first camera.

### TECHNICAL FIELD

The present disclosure relates an electronic apparatus.

### BACKGROUND ART

As is described in Patent Document 1, a technique of capturing a moving object has conventionally been suggested.

### PRIOR ART DOCUMENTS

### Patent Documents

Patent Document 1: Japanese Patent Application Laid-Open No. 2010-141671

### SUMMARY

### Problem to be Solved by the Invention

Ease of capturing a moving object is required of an electronic apparatus comprising an imaging unit.

The present invention therefore has been made in view of the above-mentioned problems and an object of the present invention is to provide a technique which is capable of capturing a moving object easily.

### Means to Solve the Problem

An electronic apparatus and a method of operating the electronic apparatus are disclosed. In one embodiment, an electronic apparatus comprises a first imaging unit capturing a first imaging range, a second imaging unit capturing a second imaging range having an angle wider than an angle of the first imaging range during a period when the first imaging unit captures the first imaging range, a display including a display screen, a detector, a determination unit, and an estimation unit. The detector detects a position of a moving object moving in the second imaging range based on an image signal from the second imaging unit. The determination unit determines whether or not there is the moving object outside the first imaging range and inside the second imaging range based on the position of the moving object detected by the detector. If the determination unit determines that there is the moving object outside the first imaging range and inside the second imaging range, the estimation unit estimates an approach area through which the moving object passes at a time of entering the first imaging range in a periphery of the first imaging range based on the position of the moving object detected by the detector. The display displays first notification information for notifying the approach area on the display screen together with a first live view image captured by the first imaging unit.

In one embodiment, a method of operating an electronic apparatus is a method of operating an electronic apparatus which comprises a first imaging unit capturing a first imaging range, a second imaging unit capturing a second imaging range having an angle wider than an angle of the first imaging range during a period when the first imaging unit captures the first imaging range. The method of operating the electronic apparatus comprises: a first step of detecting a position of a moving object moving in the second imaging range based on an image signal from the second imaging unit; a second step of determining whether or not there is the moving object outside the first imaging range and inside the second imaging range based on the position of the moving object; a third step of estimating an approach area through which the moving object passes at a time of entering the first imaging range in a periphery of the first imaging range based on the position of the moving object if it is determined that there is the moving object outside the first imaging range and inside the second imaging range in the second step; and a fourth step of displaying notification information for notifying the approach area together with a live view image captured by the first imaging unit.

In one embodiment, a control program is a control program for controlling an electronic apparatus which comprises a first imaging unit capturing a first imaging range, a second imaging unit capturing a second imaging range having an angle wider than an angle of the first imaging range during a period when the first imaging unit captures the first imaging range. The control program makes the electronic apparatus execute: a first step of detecting a position of a moving object moving in the second imaging range based on an image signal from the second imaging unit; a second step of determining whether or not there is the moving object outside the first imaging range and inside the second imaging range based on the position of the moving object; a third step of estimating an approach area through which the moving object passes at a time of entering the first imaging range in a periphery of the first imaging range based on the position of the moving object if it is determined that there is the moving object outside the first imaging range and inside the second imaging range in the second step; and a fourth step of displaying notification information for notifying the approach area together with a live view image captured by the first imaging unit.

### Effects of the Invention

The moving object can be easily captured.

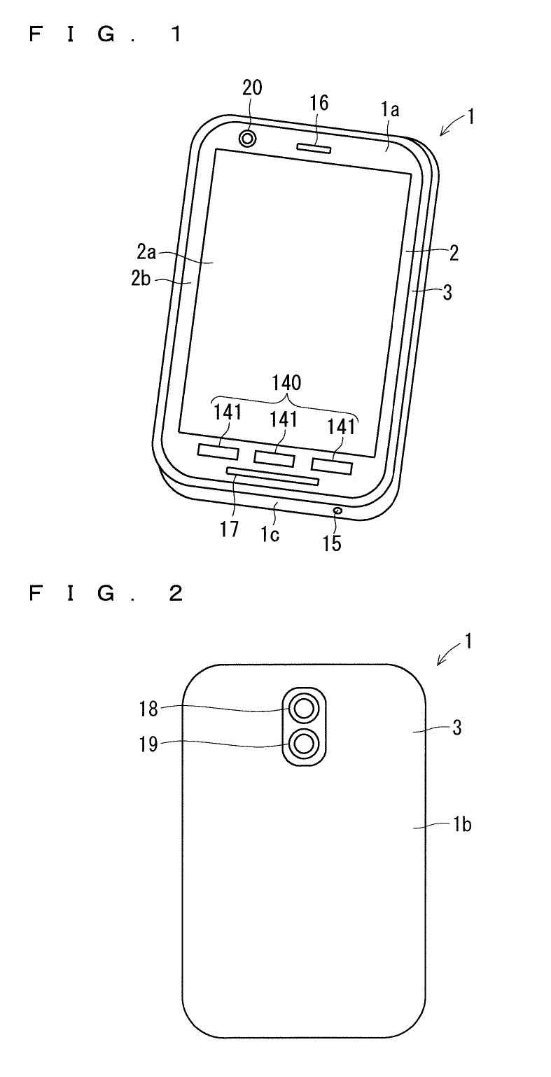

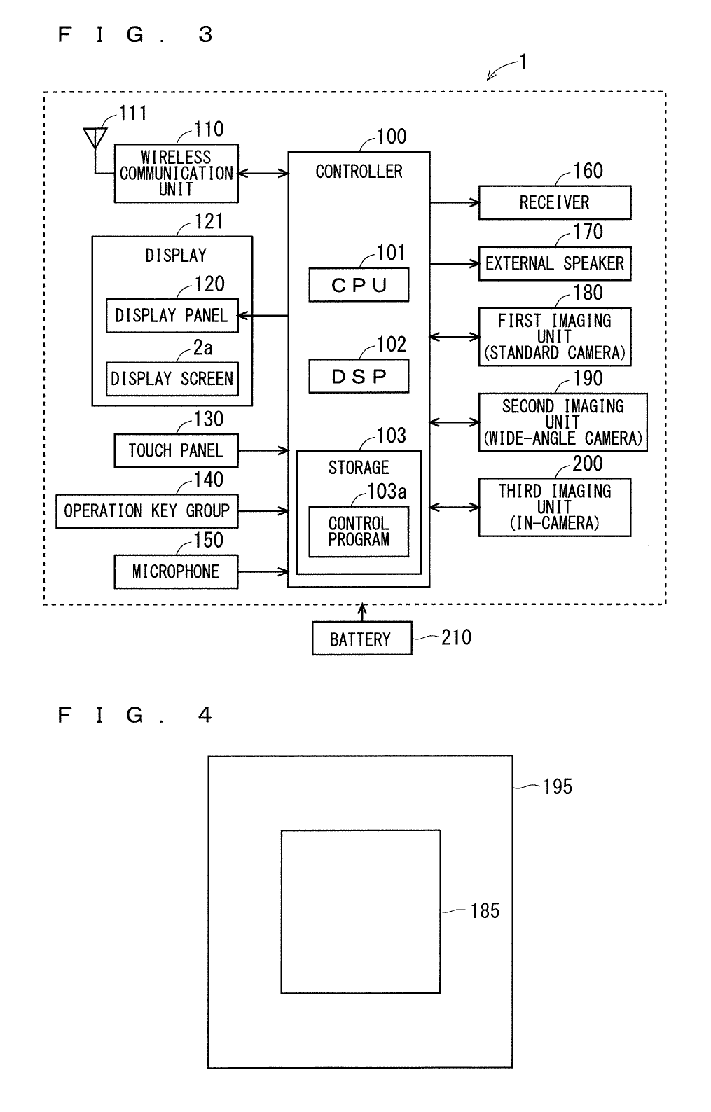

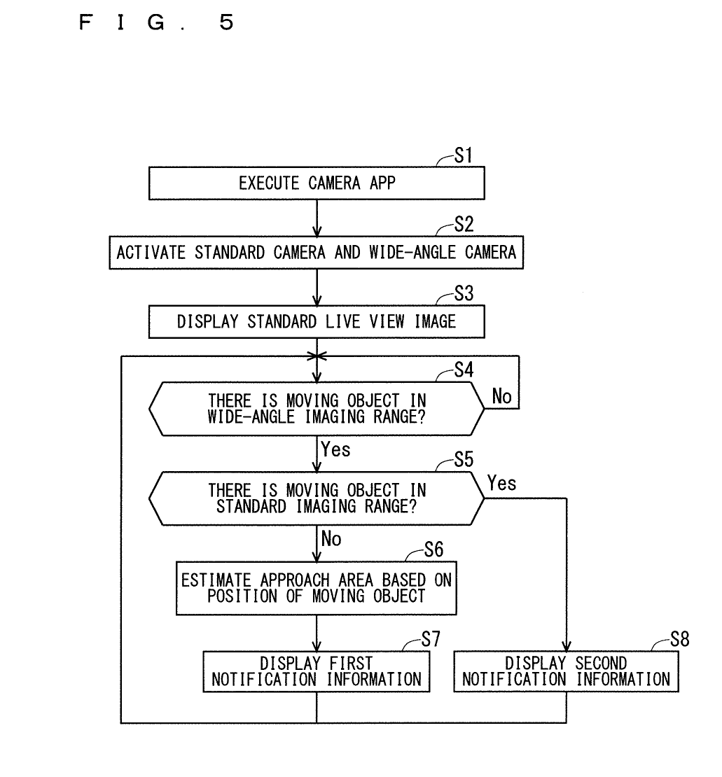

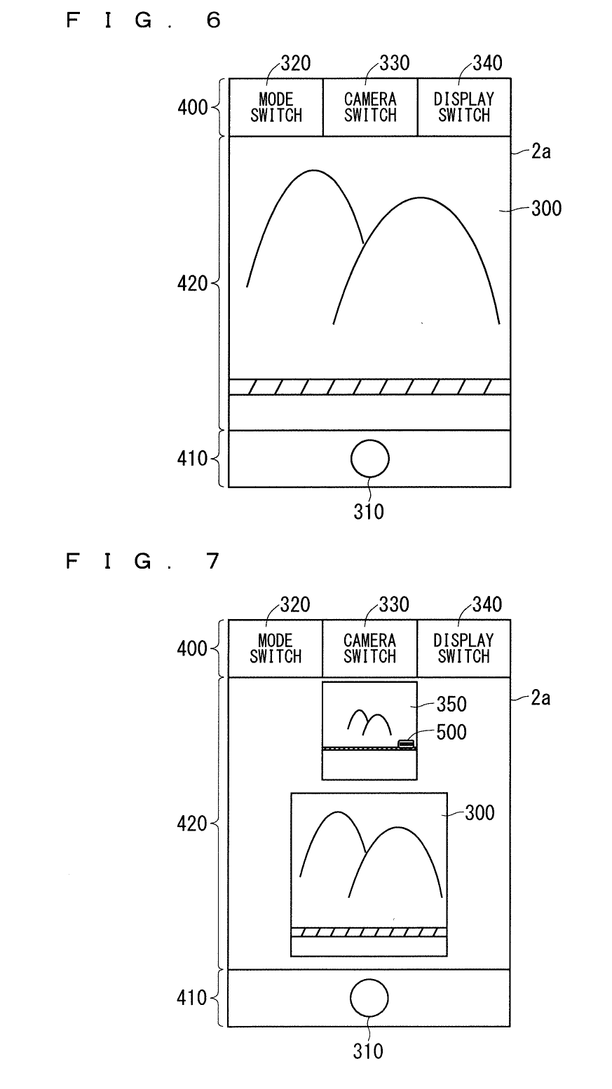

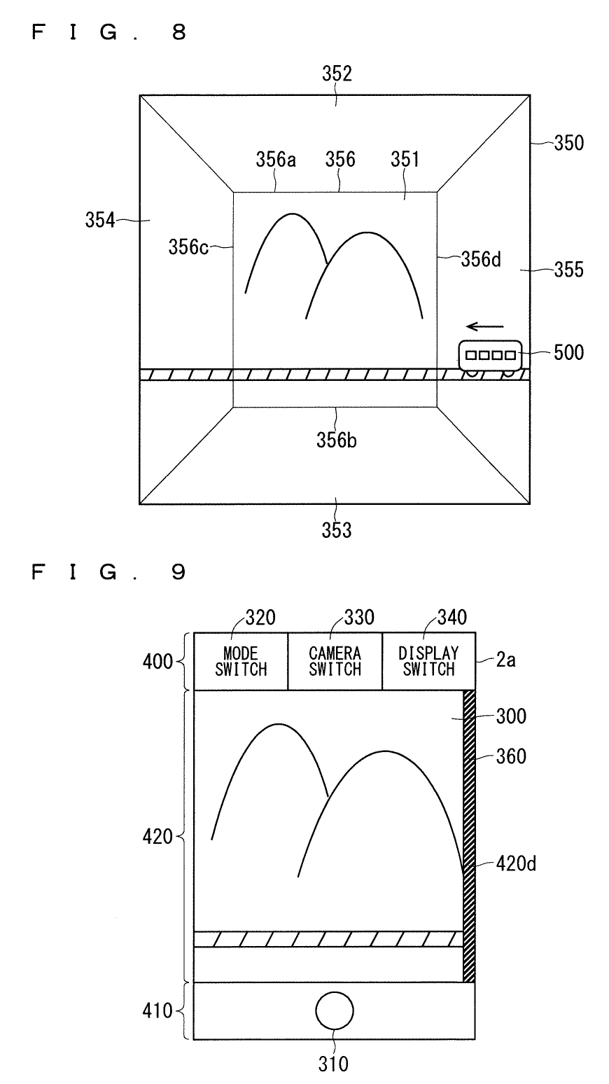

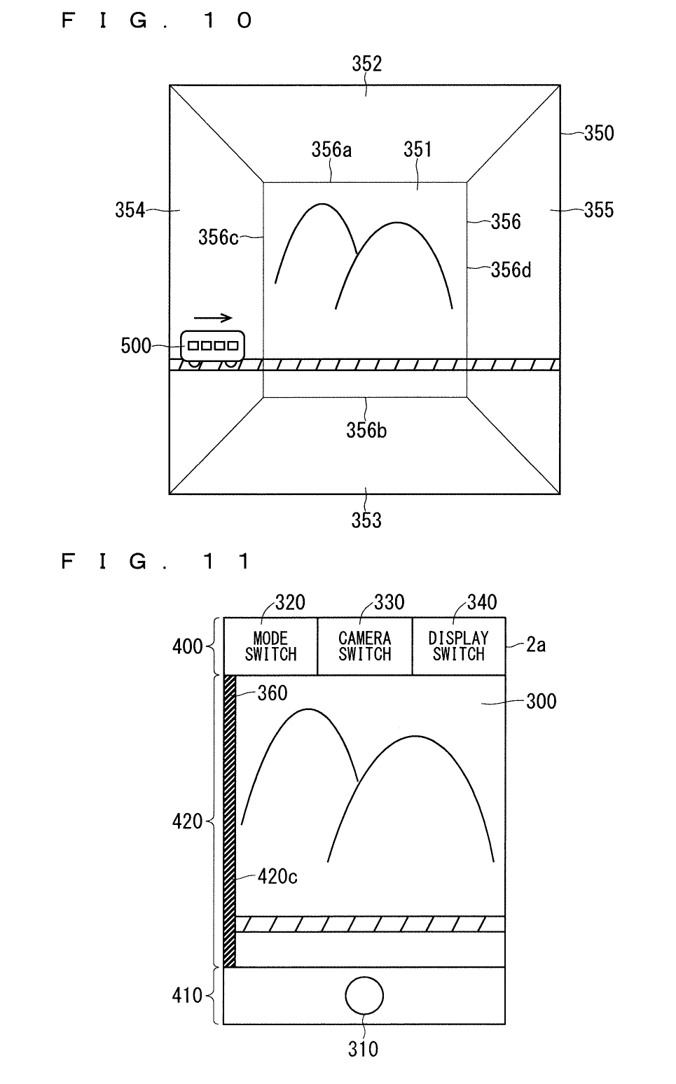

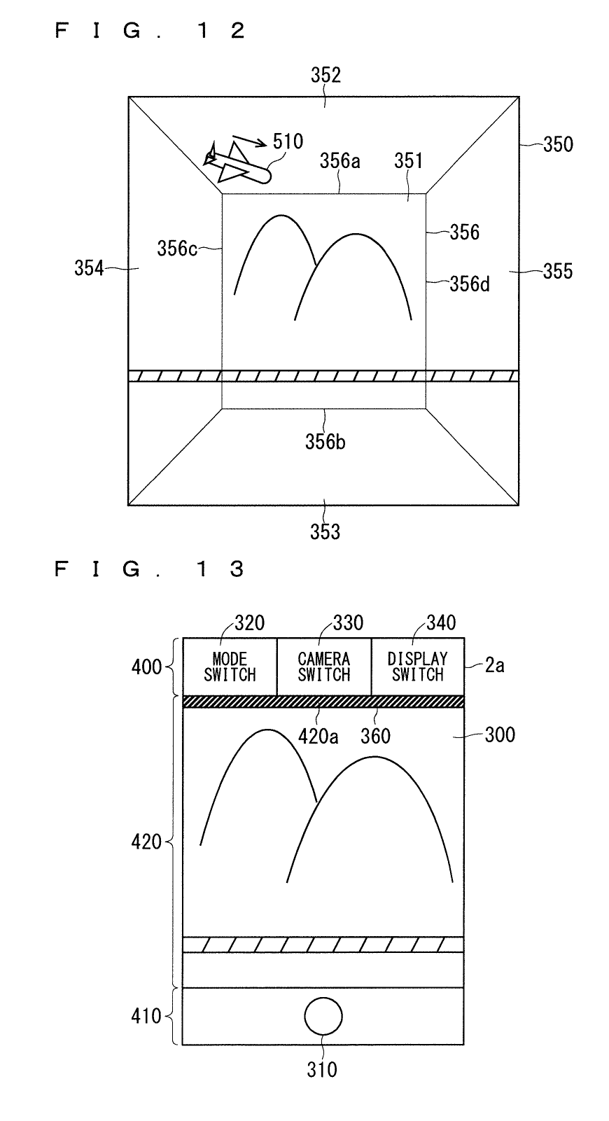

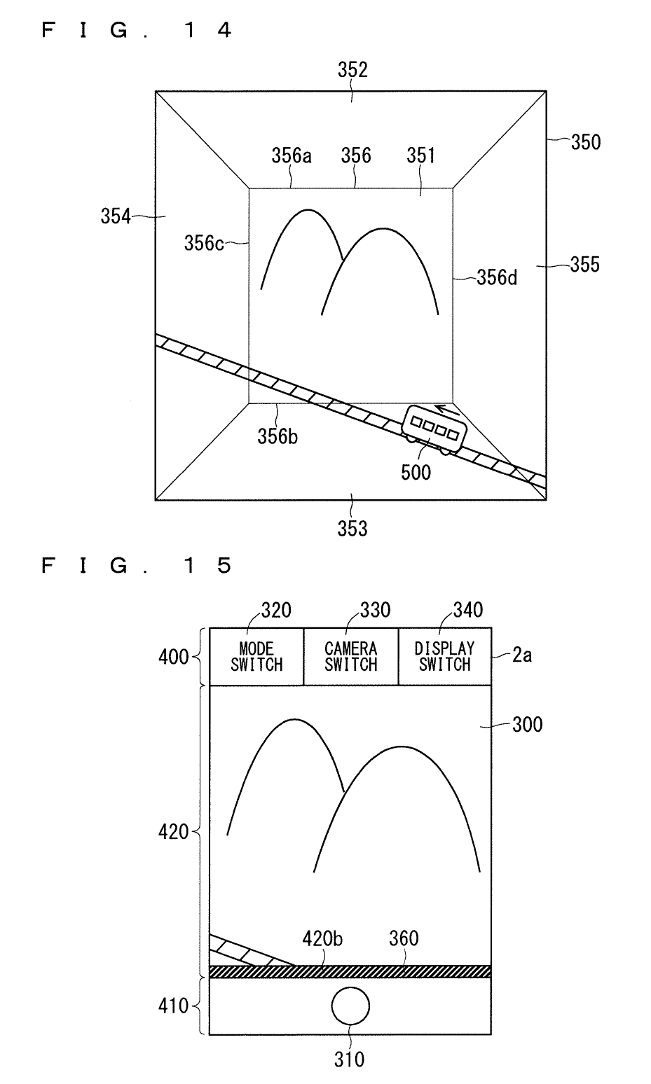

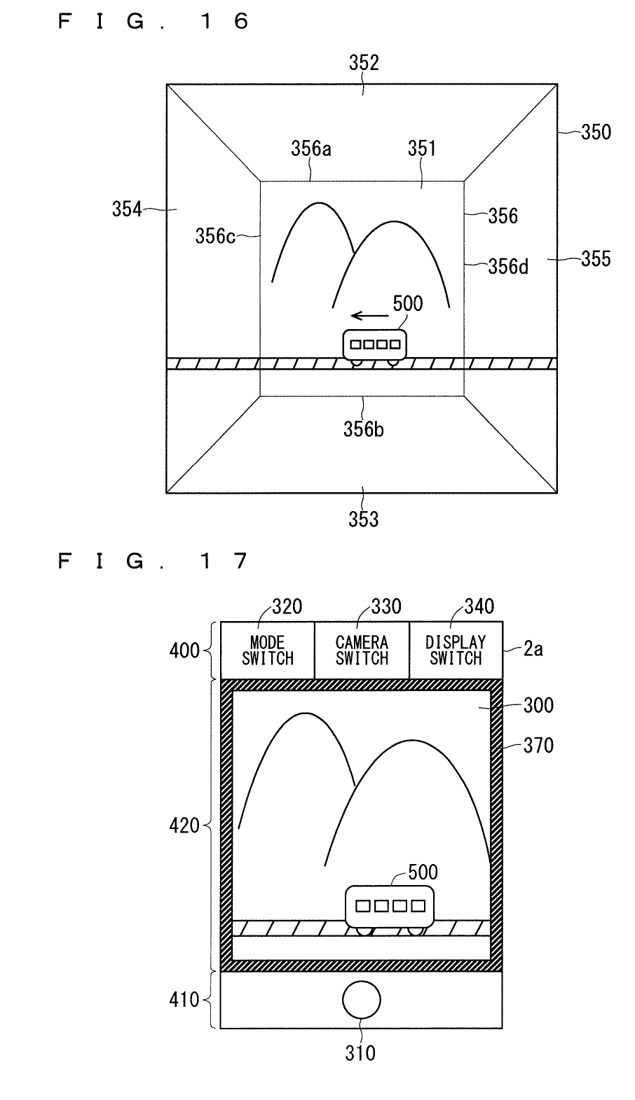

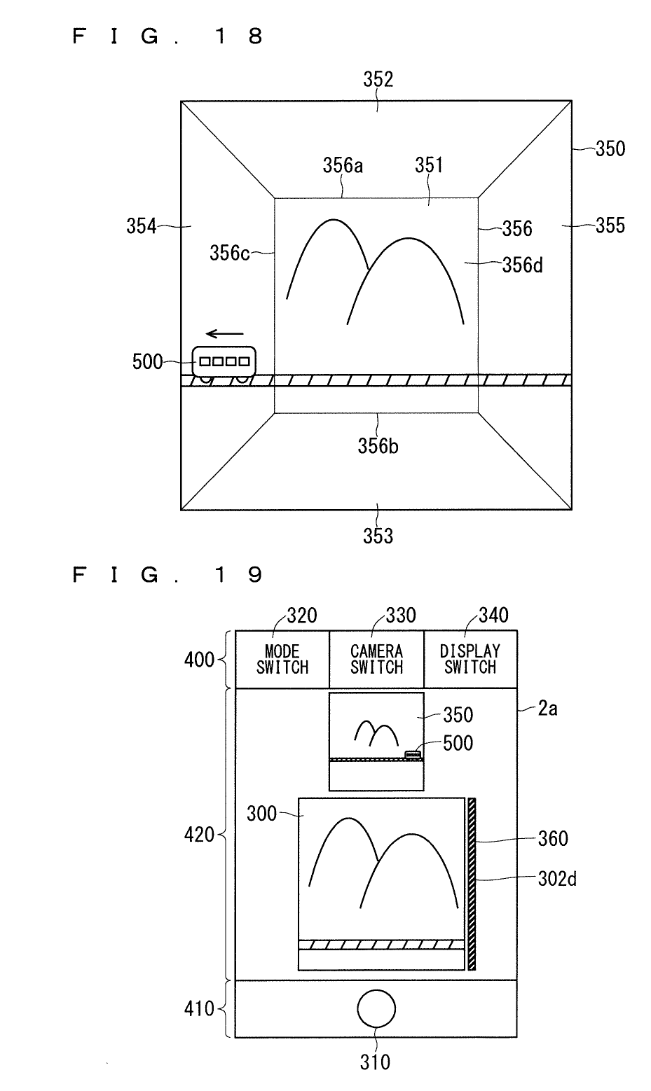

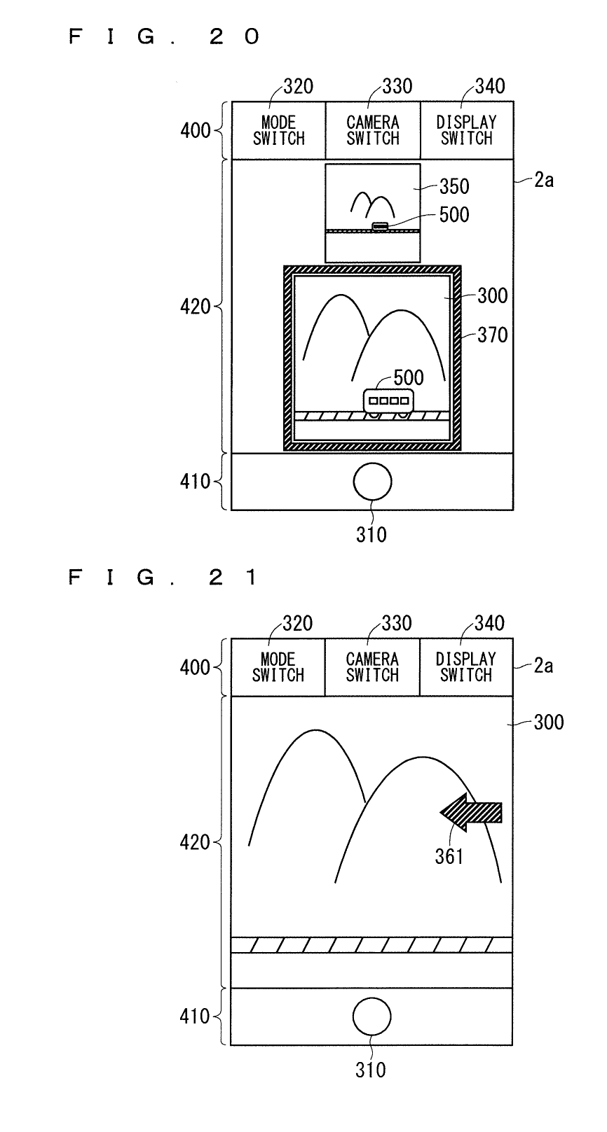

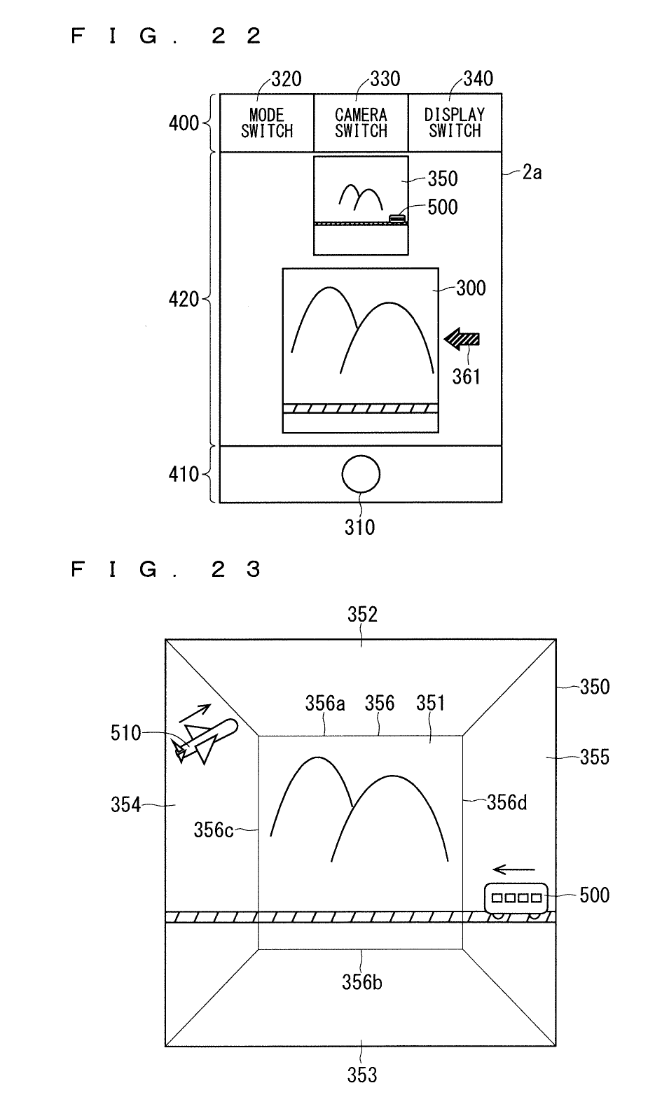

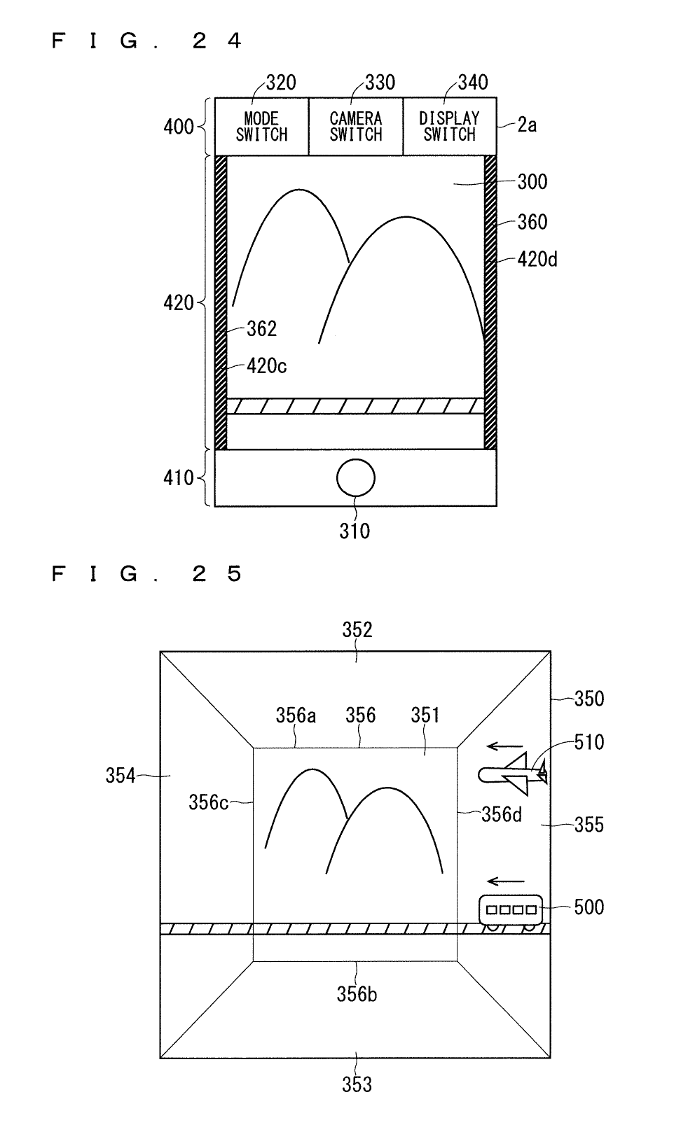

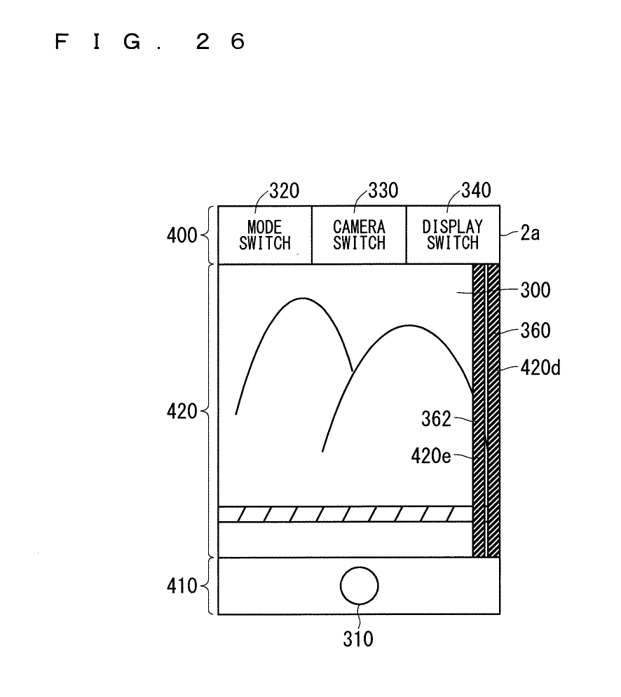

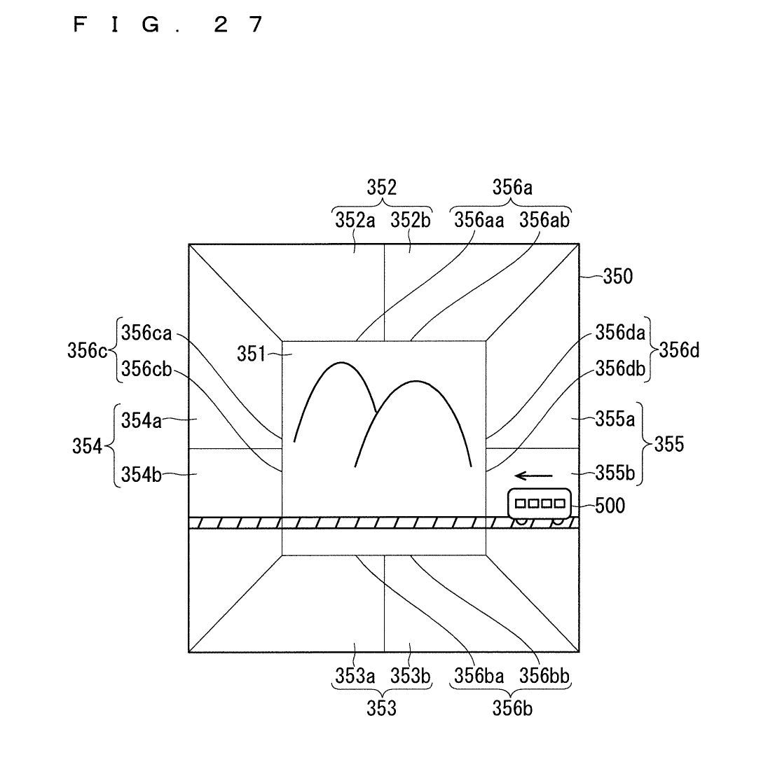

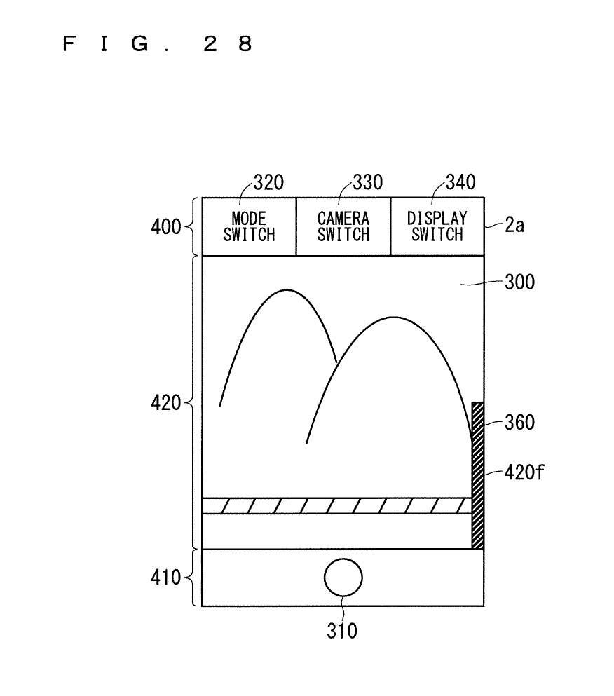

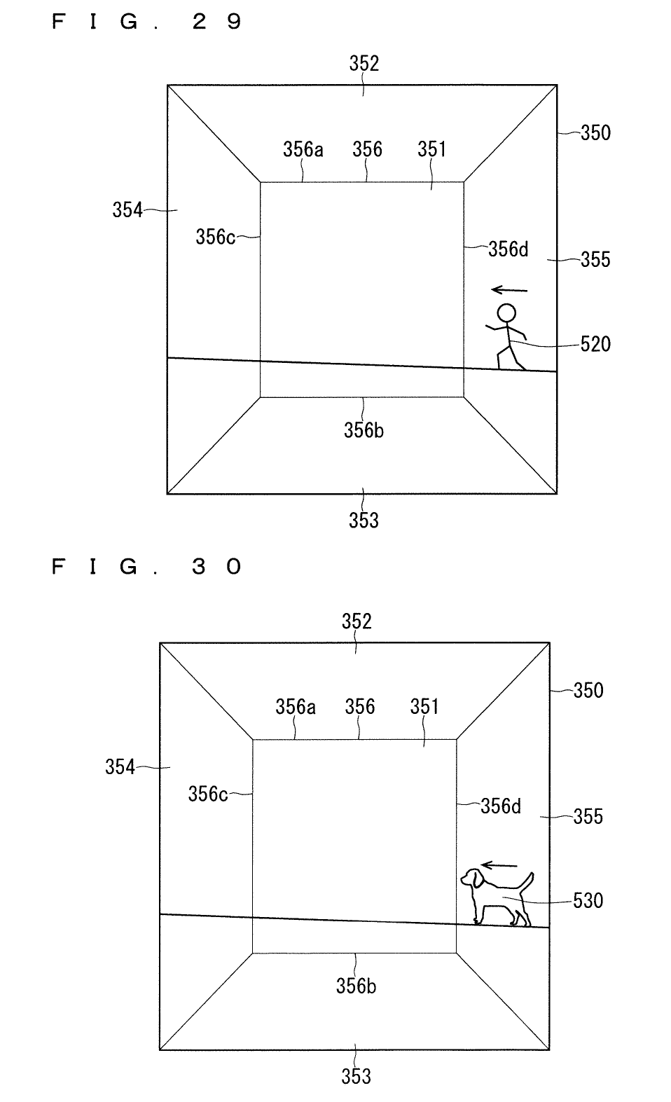

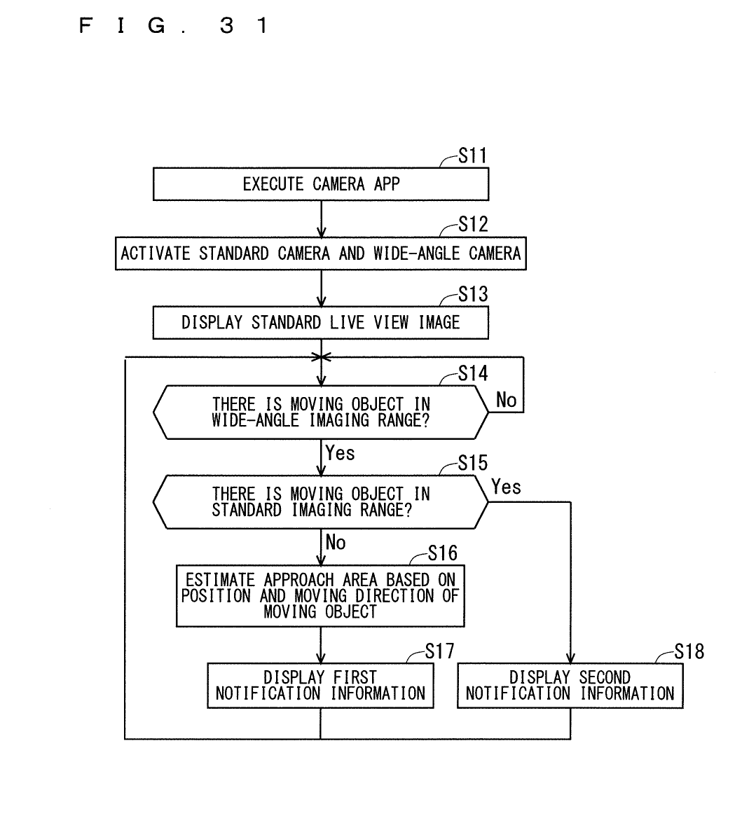

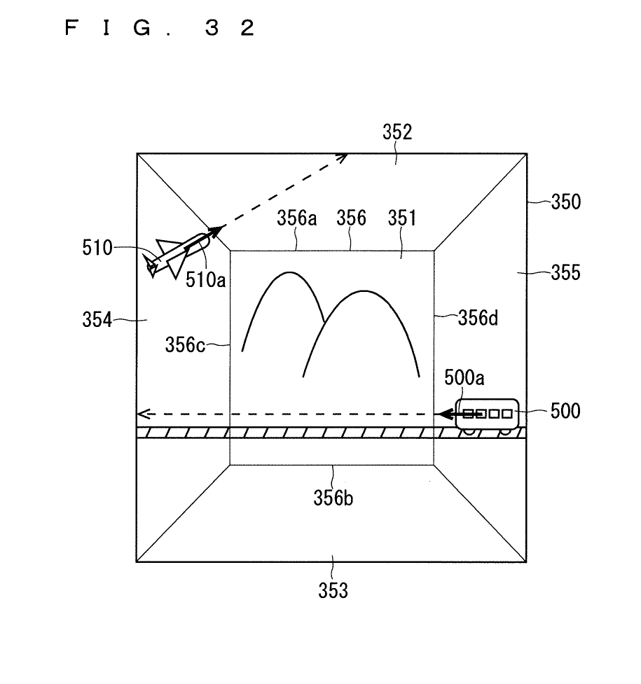

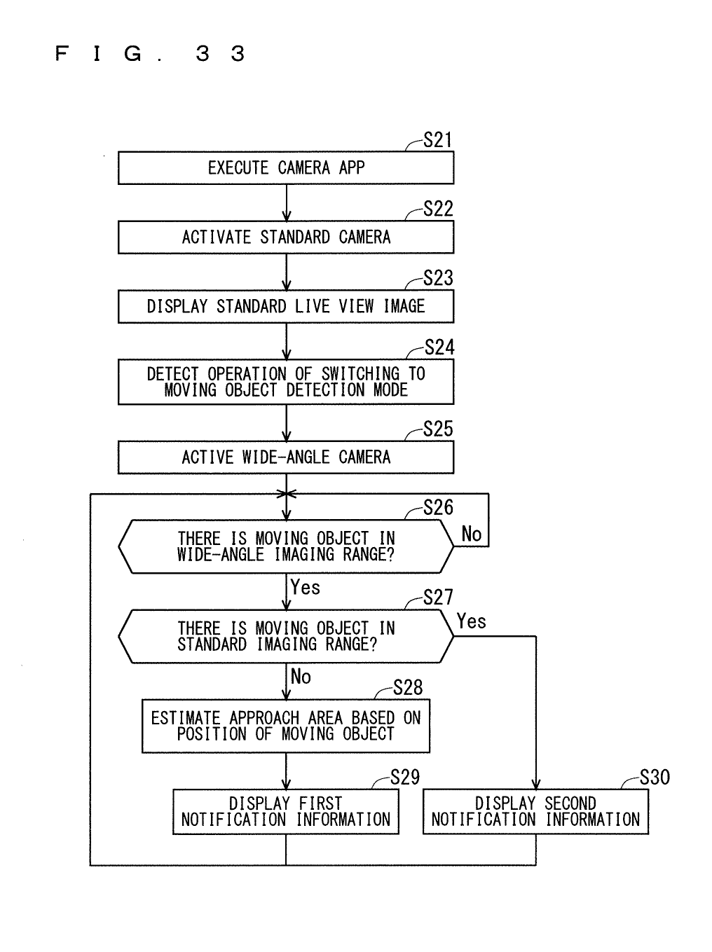

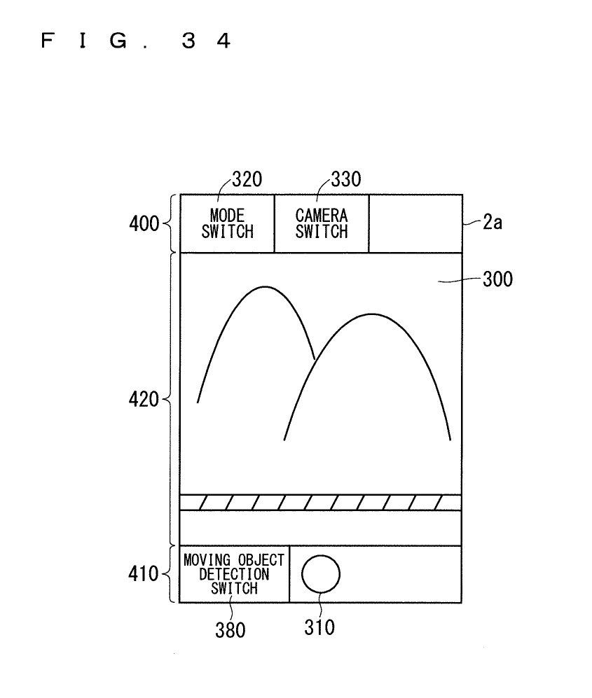

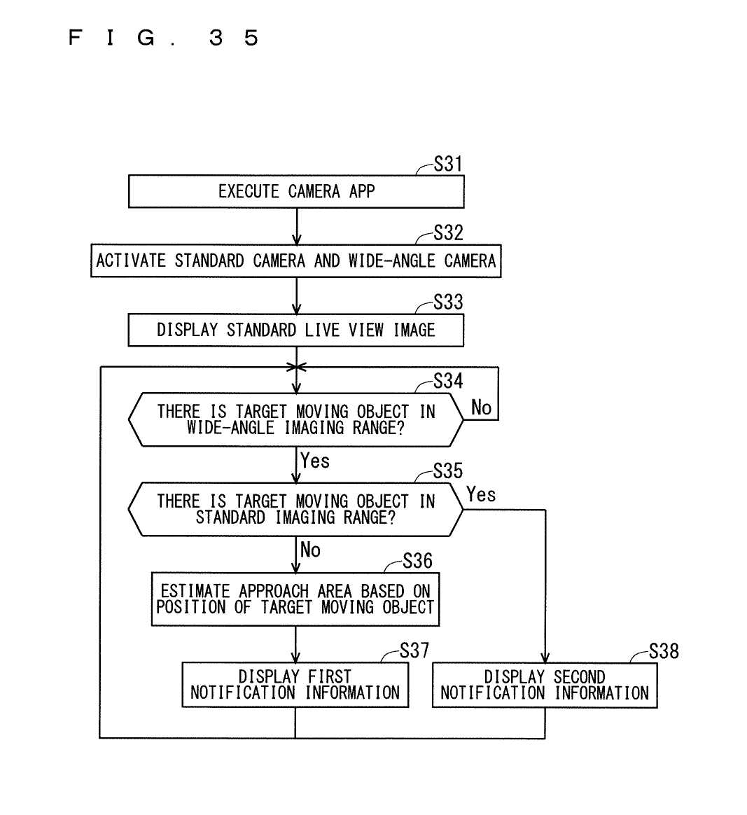

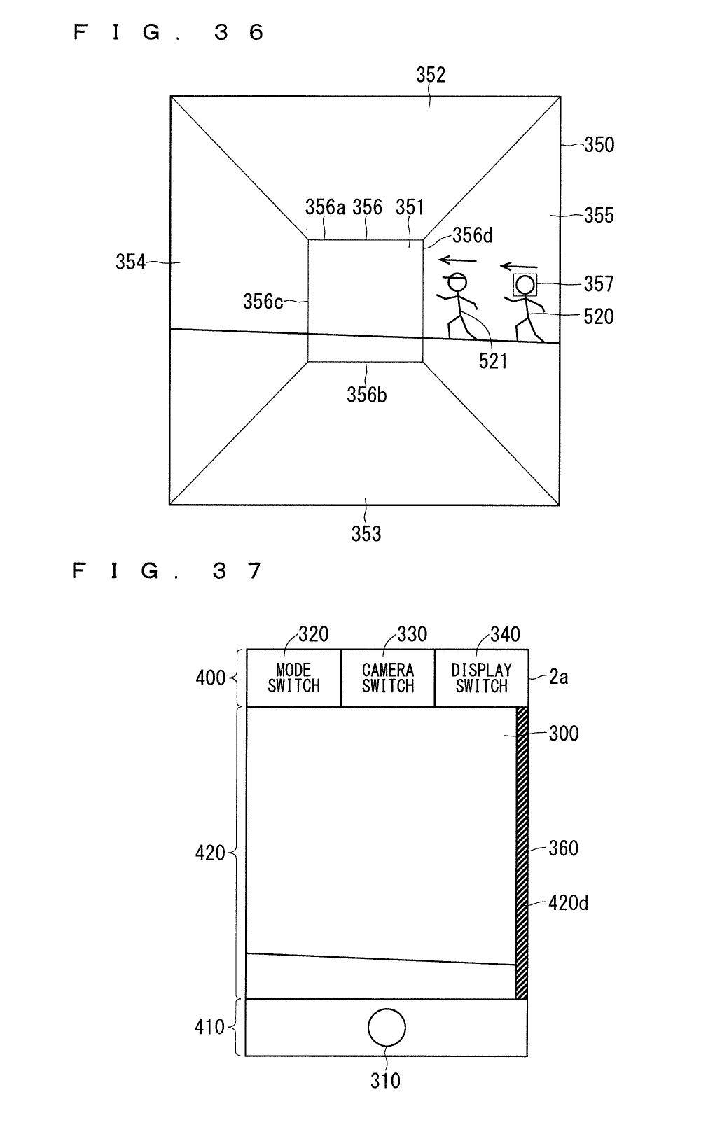

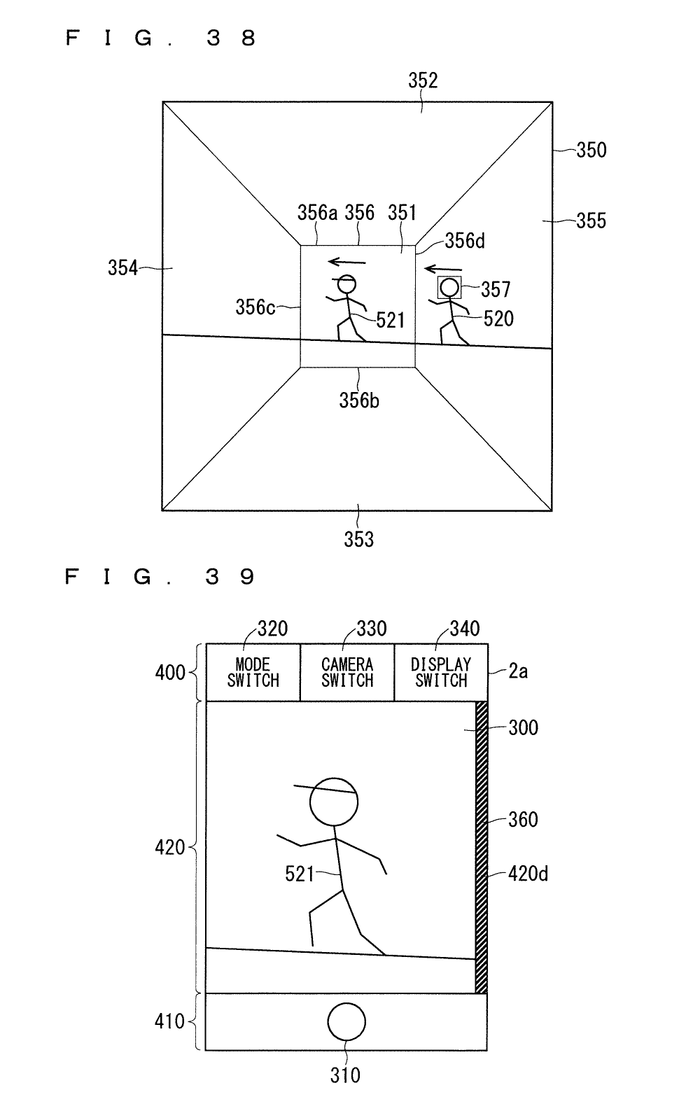

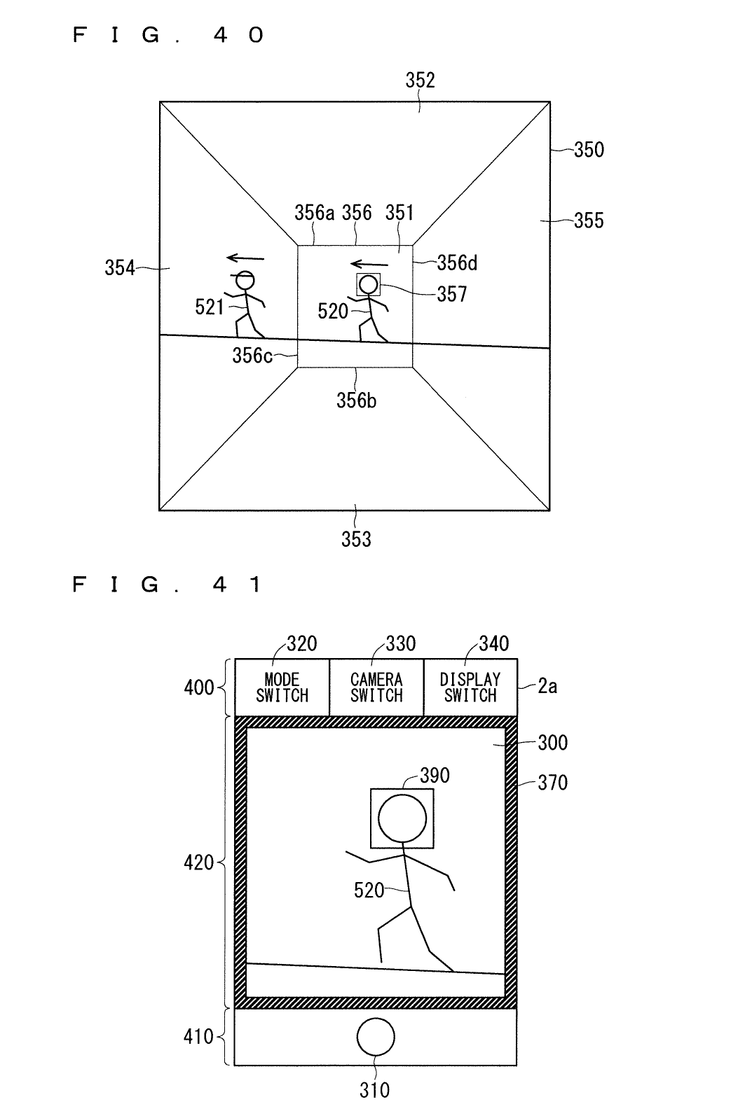

### BRIEF DESCRIPTION OF DRAWINGS

[FIG. 1] A perspective view schematically showing an example of an external appearance of an electronic apparatus.

[FIG. 2] A rear view schematically showing an example of the external appearance of the electronic apparatus.

[FIG. 3] A drawing showing an example of an electrical configuration of the electronic apparatus.

[FIG. 4] A drawing schematically showing an example of a relationship between a first imaging range and a second imaging range.

[FIG. 5] A flow chart illustrating an example of an operation of the electronic apparatus.

[FIG. 6] A drawing showing an example of a display of a display screen.

[FIG. 7] A drawing showing an example of a display of a display screen.

[FIG. 8] A drawing showing an example of a wide-angle live view image.

[FIG. 9] A drawing showing an example of a display of a display screen.

[FIG. 10] A drawing showing an example of a wide-angle live view image.

[FIG. 11] A drawing showing an example of a display of a display screen.

[FIG. 12] A drawing showing an example of a wide-angle live view image.

[FIG. 13] A drawing showing an example of a display of a display screen.

[FIG. 14] A drawing showing an example of a wide-angle live view image.

[FIG. 15] A drawing showing an example of a display of a display screen.

[FIG. 16] A drawing showing an example of a wide-angle live view image.

[FIG. 17] A drawing showing an example of a display of a display screen.

[FIG. 18] A drawing showing an example of a wide-angle live view image.

[FIG. 19] A drawing showing an example of a display of a display screen.

[FIG. 20] A drawing showing an example of a display of a display screen.

[FIG. 21] A drawing showing an example of a display of a display screen.

[FIG. 22] A drawing showing an example of a display of a display screen.

[FIG. 23] A drawing showing an example of a wide-angle live view image.

[FIG. 24] A drawing showing an example of a display of a display screen.

[FIG. 25] A drawing showing an example of a wide-angle live view image.

[FIG. 26] A drawing showing an example of a display of a display screen.

[FIG. 27] A drawing showing an example of a wide-angle live view image.

[FIG. 28] A drawing showing an example of a display of a display screen.

[FIG. 29] A drawing showing an example of a wide-angle live view image.

[FIG. 30] A drawing showing an example of a wide-angle live view image.

[FIG. 31] A flow chart illustrating an example of an operation of the electronic apparatus.

[FIG. 32] A drawing showing an example of a wide-angle live view image.

[FIG. 33] A flow chart illustrating an example of an operation of the electronic apparatus.

[FIG. 34] A drawing showing an example of a display of a display screen.

[FIG. 35] A flow chart illustrating an example of an operation of the electronic apparatus.

[FIG. 36] A drawing showing an example of a wide-angle live view image.

[FIG. 37] A drawing showing an example of a display of a display screen.

[FIG. 38] A drawing showing an example of a wide-angle live view image.

[FIG. 39] A drawing showing an example of a display of a display screen.

[FIG. 40] A drawing showing an example of a wide-angle live view image.

[FIG. 41] A drawing showing an example of a display of a display screen.

### DESCRIPTION OF EMBODIMENT(S)

<External Appearance of Electronic Apparatus>

FIG. 1 and FIG. 2 illustrate a perspective view and a rear view, respectively, each of which schematically shows an example of an external appearance of an electronic apparatus 1. The electronic apparatus 1 is, for example, a mobile phone such as a smartphone. The electronic apparatus 1 can communicate with another communication apparatus through a base station, a server, and the like.

As illustrated in FIG. 1 and FIG. 2, the electronic apparatus 1 includes a cover panel 2 located on a front surface la of the electronic apparatus 1 and an apparatus case 3 to which the cover panel 2 is attached. The cover panel 2 and the apparatus case 3 constitute an outer package of the electronic apparatus 1. The electronic apparatus 1 has, for example, a plate shape substantially rectangular in a plan view.

The cover panel 2 is provided with a display screen (display area) 2a on which various types of information such as characters, symbols, and graphics displayed by a display panel 121, which will be described below, are displayed. A peripheral part 2b surrounding the display screen 2a in the cover panel 2 is mostly black through, for example, application of a film. Most of the peripheral part 2b of the cover panel 2 accordingly serves as a non-display area on which the various types of information, which are displayed by the display panel 120, are not displayed.

Attached to a rear surface of the cover panel 2 is a touch panel 130, which will be described below. The display panel 120 is attached to a main surface opposite to the other main surface on the cover panel 2 side of the touch panel 130. In other words, the display panel 120 is attached to the rear surface of the cover panel 2 through the touch panel 130. The user can accordingly provide various instructions to the electronic apparatus 1 by operating the display screen 2a with an operator such as a finger.

As illustrated in FIG. 1, provided in an upper-side end portion of the cover panel 2 is a third-lens transparent part 20 that enables a lens of a third imaging unit 200, which will be described below, to be visually recognized from the outside of the electronic apparatus 1. Provided in the upper-side end portion of the cover panel 2 is a receiver hole 16. Provided in a lower-side end portion of the cover panel 2 is a speaker hole 17. Additionally, a microphone hole 15 is located in a bottom surface 1c of the electronic apparatus 1, or, a bottom surface (a lower side surface) of the apparatus case 3.

As illustrated in FIG. 2, provided in a back surface 1b of the electronic apparatus 1, or, in an upper-side end portion of a back surface of the apparatus case 3 is a first-lens transparent part 18 that enables an imaging lens of a first imaging unit 180, which will be described below, to be visually recognized from the outside of the electronic apparatus 1. Provided in the upper-side end portion of the back surface of the apparatus case 3 is a second-lens transparent part 19 that enables an imaging lens of a second imaging unit 190, which will be described below, to be visually recognized from the outside of the electronic apparatus 1. The first-lens transparent part 18 and the second-lens transparent part 19 are located in the back surface of the apparatus case 3 side by side along a longitudinal direction of the apparatus case 3, for example.

Provided inside the apparatus case 3 is an operation key group 140 including a plurality of operation keys 141. Each operation key 141 is a hardware key such as a press button, and a surface there of is exposed from a lower-side end portion of the cover panel 2. The user can provide various instructions to the electronic apparatus 1 by pressing each operation key 141 with the finger or the like. The plurality of operation keys 141 include, for example, a home key, a back key, and a task key. The home key is an operation key for making the display screen 2a display a home screen (initial screen). The back key is an operation key for switching the display of the display screen 2a to its previous screen. The task key is an operation key for making the display screen 2a display a list of application programs being executed by the electronic apparatus 1.

<Electrical Configuration of Electronic Apparatus>

FIG. 3 is a block diagram showing an example of an electrical configuration of the electronic apparatus 1. As illustrated in FIG. 3, the electronic apparatus 1 includes a controller 100, a wireless communication unit 110, a display 121, a touch panel 130, the operation key group 140, a microphone 150, a receiver 160, an external speaker 170, a first imaging unit 180, a second imaging unit 190, a third imaging unit 200, and a battery 210. The apparatus case 3 houses each of these components provided in the electronic apparatus 1.

The controller 100 is a computer and includes, for example, a central processing unit (CPU) 101, a digital signal processor (DSP) 102, and a storage 103. The controller 100 is also considered as a control circuit. The controller 100 controls other components of the electronic apparatus 1 to be able to collectively manage the operation of the electronic apparatus 1. The controller 100 may further include a co-processor such as, for example, a system-on-a-chip (SoC), a micro control unit (MCU), and a field-programmable gate array (FPGA). In the above case, the controller 100 may make a CPU 101 and the co-processor cooperate with each other or switch between them and use one of them to perform various types of control.

The storage 103 includes a non-transitory recording medium readable by the CPU 101 and a DSP 102 such as a read only memory (ROM) and a random access memory (RAM). The ROM of the storage 103 is, for example, a flash ROM (flash memory) that is a non-volatile memory. The storage 103 stores a plurality of control programs 103a to control the electronic apparatus 1. The plurality of control programs 103a include a main program and a plurality of application programs (also merely referred to as “applications” or “apps” in some cases hereinafter). The CPU 101 and the DSP 102 execute the various control programs 103a in the storage 103 to achieve various functions of the controller 100. The storage 103 stores, for example, an application program for capturing a still image or video (also referred to as a “camera app” hereinafter) using the first imaging unit 180, the second imaging unit 190, or the third imaging unit 200.

The storage 103 may include a non-transitory computer readable recording medium other than the ROM and the RAM. The storage 103 may include, for example, a compact hard disk drive and a solid state drive (SSD). All or some of the functions of the controller 100 may be achieved by hardware that needs no software to achieve the functions above.

The wireless communication unit 110 includes an antenna 111. The wireless communication unit 110 can receive, for example, a signal from a mobile phone different from the electronic apparatus 1 or a signal from a communication apparatus such as a web server connected to Internet through the antenna 111 via a base station. The wireless communication unit 110 can amplify and down-convert the signal received by the antenna 111 and then output a resultant signal to the controller 100. The controller 100 can, for example, modulate the received signal to acquire information such as a sound signal indicative of the voice or music contained in the received signal.

The wireless communication unit 110 can also up-convert and amplify a transmission signal generated by the controller 100 to wirelessly transmit the processed transmission signal from the antenna 111. The transmission signal from the antenna 111 is received, via the base station, by the mobile phone different from the electronic apparatus 1 or the communication apparatus such as the web server connected to Internet, for example.

The display 121 includes the display panel 120 and the display screen 2a. The display panel 120 is, for example, a liquid crystal panel or an organic EL panel. The display panel 120 can display various types of information such as characters, symbols, and graphics under the control of the controller 100. The various types of information, which the display panel 121 displays, are displayed on the display screen 2a.

The touch panel 130 is, for example, a projected capacitive touch panel. The touch panel 130 can detect an operation performed on the display screen 2a with the operator such as the finger. When the user operates the display screen 2a with the operator such as the finger, an electrical signal corresponding to the operation is entered from the touch panel 130 to the controller 100. The controller 100 can accordingly specify contents of the operation performed on the display screen 2a based on the electrical signal from the touch panel 130, thereby performing the process in accordance with the contents. The user can also provide the various instructions to the electronic apparatus 1 by operating the display screen 2a with, for example, a pen for capacitive touch panel such as a stylus pen, instead of the operator such as the finger.

When the user operates each operation key 141 of the operation key group 140, the operation key 141 outputs to the controller 100 an operation signal indicating that the operation key 141 has been operated. The controller 100 can accordingly determine, based on the operation signal from each operation key 141, whether or not the operation key 141 has been operated. The controller 100 can perform the operation corresponding to the operation key 141 that has been operated. Each operation key 141 may be a software key displayed on the display screen 2a instead of a hardware key such as a push button. In this case, the touch panel 130 detects the operation performed on the software key, so that the controller 100 can perform the process corresponding to the software key that has been operated.

The microphone 150 can convert the sound from the outside of the electronic apparatus 1 into an electrical sound signal and then output the electrical sound signal to the controller 100. The sound from the outside of the electronic apparatus 1 is, for example, taken inside the electronic apparatus 1 through the microphone hole 15 located in the bottom surface (lower side surface) of the apparatus case 3 and entered to the microphone 150.

The external speaker 170 is, for example, a dynamic speaker. The external speaker 170 can convert an electrical sound signal from the controller 100 into a sound and then output the sound. The sound being output from the external speaker 170 is, for example, output to the outside of the electronic apparatus 1 through the speaker hole 17 located in the lower-side end portion of the cover panel 2. The sound being output from the speaker hole 17 is set to a volume high enough to be heard in the place apart from the electronic apparatus 1.

The receiver 160 can output a received sound and is, for example, a dynamic speaker. The receiver 160 can convert an electrical sound signal from the controller 100 into a sound and then output the sound. The sound being output from the receiver 160 is, for example, output outside through the receiver hole 16 located in the upper-side end portion of the cover panel 2. A volume of the sound being output through the receiver hole 16 is set to be smaller than a volume of the sound being output from the external speaker 170 through the speaker hole 17.

The receiver 160 may be replaced with a piezoelectric vibration element. The piezoelectric vibration element can vibrate based on a voice signal from the controller 100. The piezoelectric vibration element is provided in, for example, a rear surface of the cover panel 2 and can vibrate, through its vibration based on the sound signal, the cover panel 2. When the user brings the cover panel 2 close to his/her ear, the vibration of the cover panel 2 is transmitted to the user as a voice. The receiver hole 16 is not necessary when the receiver 160 is replaced with the piezoelectric vibration element.

The battery 210 can output a power source for the electronic apparatus 1. The battery 210 is, for example, a rechargeable battery such as a lithium-ion secondary battery. The battery 210 can supply a power source to various electronic components such as the controller 100 and the wireless communication unit 110 of the electronic apparatus 1.

Each of the first imaging unit 180, the second imaging unit 190, and the third imaging unit 200 includes a lens and an image sensor, for example. Each of the first imaging unit 180, the second imaging unit 190, and the third imaging unit 200 can capture an object under the control of the controller 100, generate a still image or a video showing the captured object, and then output the still image or the video to the controller 100. The controller 100 can store the received still image or video in the non-volatile memory (flash memory) or the volatile memory (RAM) of the storage 103.

The lens of the third imaging unit 200 can be visually recognized from the third-lens transparent part 20 located in the cover panel 2. The third imaging unit 200 can thus capture an object located on the cover panel 2 side of the electronic apparatus 1, or, the front surface la side of the electronic apparatus 1. The third imaging unit 200 above is also referred to as an “in-camera”. Hereinafter, the third imaging unit 200 may be referred to as the “in-camera 200”.

The lens of the first imaging unit 180 can be visually recognized from the first-lens transparent part 18 located in the back surface 1b of the electronic apparatus 1. The lens of the second imaging unit 190 can be visually recognized from the second-lens transparent part 19 located in the back surface 1b of the electronic apparatus 1. The first imaging unit 180 and the second imaging unit 190 can thus capture an object located on the back surface 1b side of the electronic apparatus 1.

The second imaging unit 190 can capture a second imaging range with an angle (angle of view) wider than that of a first imaging range captured by the first imaging unit 180. During a time when the first imaging unit 180 captures the first imaging range, the second imaging unit 190 captures the second imaging range which has the angle (angle of view) wider than the first imaging range. In other words, when the first imaging unit 180 and the second imaging unit 190 respectively capture the first and second imaging ranges, the angle of view of the second imaging unit 190 is wider than the angle of view of the first imaging unit 180. FIG. 4 is a drawing schematically showing a relationship between a first imaging range 185 and a second imaging range 195 when the first imaging unit 180 and the second imaging unit 190 respectively capture the first imaging range 185 and the second imaging range 195. As illustrated in FIG. 4, when the first imaging unit 180 captures the first imaging range 185, the second imaging range 195 which is captured by the second imaging unit 190 is larger than the first imaging range 185 and includes the first imaging range 185.

For the sake of description, the first imaging unit 180 is referred to as a “standard camera 180”, and the second imaging unit 190 is referred to as a “wide-angle camera 190”. The first imaging range 185 captured by the standard camera 180 is referred to as a “standard imaging range 185”, and the second imaging range 195 captured by the wide-angle camera 190 is referred to as a “wide-angle imaging range 195”.

In the present example, the respective lenses of the standard camera 180, the wide-angle camera 190, and the in-camera 200 are fixed-focal-length lenses. Alternatively, at least one of the lenses of the standard camera 180, the wide-angle camera 190, and the in-camera 200 may be a zoom lens.

The electronic apparatus 1 has a zoom function for each of the standard camera 180, the wide-angle camera 190, and the in-camera 200. In other words, the electronic apparatus 1 has a standard camera zoom function of zooming in an object to be captured by the standard camera 180, a wide-angle camera zoom function of zooming in an object to be captured by the wide-angle camera 190, and an in-camera zoom function of zooming in an object to be captured by the in-camera 200. When an object to be captured is zoomed in by the camera zoom function, the imaging range becomes smaller. In the meanwhile, when an object to be captured is zoomed out by the camera zoom function, the imaging range becomes larger.

In the present example, each of the lenses of the standard camera 180, the wide-angle camera 190, and the in-camera 200 is a fixed-focal-length lens, and accordingly, each of the standard camera zoom function, the wide-angle camera zoom function, and the in-camera zoom function is a digital zoom function. Alternatively, at least one of the standard camera zoom function, the wide-angle camera zoom function, and the in-camera zoom function may be an optical zoom function achieved by a zoom lens.

Even in the case in which the electronic apparatus 1 has the standard camera zoom function and the wide-angle camera zoom function, or, each of the standard camera 180 and the wide-angle camera 190 has a variable angle of view, during a period when the standard camera 180 captures the standard imaging range 185, the wide-angle camera 190 captures the wide angle-range imaging range 195 which has the angle wider than that of the standard imaging range 185. Specifically, when the standard camera 180 and the wide-angle camera 190 each have a zoom magnification “1”, the wide-angle imaging range 195 has an angle wider than that of the standard imaging range 185. When the standard camera 180 captures the standard imaging range 185, the wide-angle camera zoom function of the electronic apparatus 1 becomes ineffective. In other words, when the standard camera 180 captures the standard imaging range 185, the zoom magnification of the wide-angle camera 190 is fixed to “1”. Thus, when the standard camera 180 captures the standard imaging range 185, the fixed angle of view of the wide-angle imaging range 195 is wider than the maximum angle of view of the standard imaging range 185.

In the meanwhile, when the standard camera 180 does not capture the standard imaging range 185 and the wide-angle camera 190 captures the wide-angle imaging range 195, the wide-angle camera zoom function of the electronic apparatus 1 becomes effective. When the wide-angle camera zoom function is effective, the minimum angle of view of the wide-angle camera 190 may be narrower than the maximum angle of view of the standard camera 180. That is to say, when the wide-angle camera zoom function is effective, the wide-angle imaging range 195 may have the angle of view narrower than the standard imaging range 185.

<Operation of Electronic Apparatus during Execution of Camera App>

FIG. 5 is a flow chart illustrating an example of an operation of the electronic apparatus 1 when the camera app is executed. When a predetermined operation is performed on the display screen 2a, as illustrated in FIG. 5, in Step S1, the controller 100 executes (activates) a camera app stored in the storage 103. For example, a home screen (initial screen) is displayed on the display screen 2a in the initial state before the electronic apparatus 1 executes various apps. On the home screen are displayed a plurality of graphics for executing the various apps (hereinafter, also referred to as app-execution graphics). The app-execution graphics may include graphics referred to as icons. When the touch panel 130 detects a user's selection operation on the app-execution graphics for executing a camera app displayed on the display screen 2a, the controller 100 executes the camera app stored in the storage 103.

Conceivable as the selection operation on the app-execution graphics displayed on the display screen 2a is an operation in which the user brings the operator such as the finger close to the app-execution graphics and then moves the operator away from the app-execution graphics, for example. Also conceivable as the selection operation on the app-execution graphics displayed on the display screen 2a is an operation in which the user brings the operator such as the finger into contact with the app-execution graphics and then moves the operator away from the app-execution graphics. These operations are called tap operations. The selection operation through this tap operation is used as the selection operation on the app-execution graphics, as well as the selection operation on various pieces of information displayed on the display screen 2a. The following will not repetitively describe the selection operation through the tap operation.

When the camera app is not executed, no power source is supplied to the standard camera 180, the wide-angle camera 190, and the in-camera 200. When starting the execution of the camera app, in step S2, the controller 100 supplies a power source to the standard camera 180 and the wide-angle camera 190 in the standard camera 180, the wide-angle camera 190, and the in-camera 200, to thereby activate the standard camera 180 and the wide-angle camera 190. When the standard camera 180 and the wide-angle camera 190 are activated, the standard camera 180 serves as a recording camera for recording a captured still image or video in a non-volatile memory, and the wide-angle camera 190 serves as a camera for performing the operation of detecting a moving object, which will be described below.

Next, in step S3, the controller 100 controls the display panel 120 to make the display screen 2a display a live view image (also referred to as a through image or a preview image, or merely referred to as a preview) showing the standard imaging range 185 captured by the standard camera 180. In other words, the controller 100 makes the display screen 2a display images, which are continuously captured at a predetermined frame rate by the standard camera 180, in real time. The live view image is an image displayed for the user to check images captured continuously in real time. The plurality of live view images displayed continuously are also considered as a type of video. Each live view image is also considered as each frame image of the video. While a still image and a video for recording, which will be described below, are stored in the non-volatile memory of the storage 103, a live view image is temporarily stored in the volatile memory of the storage 103 and then displayed on the display screen 2a by the controller 100. Hereinafter, the live view image captured by the standard camera 180 is also referred to as a “standard live view image”.

FIG. 6 is a drawing showing an example of a display of the display screen 2a on which a standard live view image 300 is displayed. As illustrated in FIG. 6, the standard live view image 300 is displayed in a central area 420 (an area other than an upper end portion 400 and a lower end portion 410) of the display screen 2a. In other words, an object within the standard imaging range 185 is displayed in the central area 420 of the display screen 2a.

During the execution of the camera app, as illustrated in FIG. 6, an operation button 310 is displayed in the lower end portion 410 of the display screen 2a. On the upper end portion 400 of the display screen 2a are displayed a mode switch button 320, a camera switch button 330, and a display switch button 340.

The mode switch button 320 is an operation button for switching a capturing mode of the electronic apparatus 1. In the case in which the capturing mode of the electronic apparatus 1 is a still image capturing mode, when the touch panel 130 detects a predetermined operation (e.g., a tap operation) on the mode switch button 320, the controller 100 switches the capturing mode of the electronic apparatus 1 from the still image capturing mode to a video capturing mode. In the case in which the capturing mode of the electronic apparatus 1 is the video capturing mode, when the touch panel 130 detects a predetermined operation on the mode switch button 320, the controller 100 switches the capturing mode of the electronic apparatus 1 from the video capturing mode to the still image capturing mode.

The camera switch button 330 is an operation button for switching a recording camera for recording a still image or a video. In the case in which the recording camera is the standard camera 180, when the touch panel 130 detects a predetermined operation (e.g., a tap operation) on the camera switch button 330, the controller 100 switches the recording camera from the standard camera 180 to, for example, the wide-angle camera 190. When the recording camera is switched from the standard camera 180 to the wide-angle camera 190, the controller 100 stops supplying a power source to the standard camera 180 to stop the operation of the standard camera 180. When the recording camera is switched from the standard camera 180 to the wide-angle camera 190, the display 121 displays a live view image showing the wide-angle imaging range 195 captured by the wide-angle camera 190, in place of the standard live view image 300 (hereinafter referred to as a wide-angle live view image), on the display screen 2a.

In the case in which the recording camera is the wide-angle camera 190, when the touch panel 130 detects a predetermined operation on the camera switch button 330, the controller 100 switches the recording camera from the wide-angle camera 190 to, for example, the in-camera 200. When the recording camera is switched from the wide-angle camera 190 to the in-camera 200, the controller 100 supplies a power source to the in-camera 200 to activate the in-camera 200. The controller 100 then stops supplying a power source to the wide-angle camera 190 to stop the operation of the wide-angle camera 190. When the recording camera is switched from the wide-angle camera 190 to the in-camera 200, the display 121 displays a live view image captured by the in-camera 200, in place of a wide-angle live view image, on the display screen 2a.

In the case in which the recording camera is the in-camera 200, when the touch panel 130 detects a predetermined operation on the camera switch button 330, the controller 100 switches the recording camera from the in-camera 200 to, for example, the standard camera 180. When the recording camera is switched from the in-camera 200 to the standard camera 180, the controller 100 supplies a power source to the standard camera 180 and the wide-angle camera 190 to activate the standard camera 180 and the wide-angle camera 190, respectively. The controller 100 then stops supplying a power source to the in-camera 200 to stop the operation of the in-camera 200. When the recording camera is switched from the in-camera 200 to the standard camera 180, the display 121 displays a standard live view image 300, in place of a live view image captured by the in-camera 200, on the display screen 2a.

The recording camera at the time of activating a camera app may be the wide-angle camera 190 or the in-camera 200, instead of the standard camera 180.

The other order of switching the recording cameras may also be applied as well as the order in the example above. It is also applicable that, for example, the recording camera is switched from the standard camera 180 to the in-camera 200 when the recording camera is the standard camera 180 in the case where the operation on the camera switch button 330 is detected, the recording camera is switched from the in-camera 200 to the wide-angle camera 190 when the recording camera is the in-camera 200 in the case where the operation on the camera switch button 330 is detected, and the recording camera is switched from the wide-angle camera 190 to the standard camera 180 when the recording camera is the wide-angle camera 190 in the case where the operation on the camera switch button 330 is detected.

The display 121 may display two camera switch buttons for switching over to two cameras other than the recording camera in the standard camera 180, the wide-angle camera 190, and the in-camera 200, in place of the camera switch button 330 for sequentially switching the recording cameras, on the display screen 2a. Specifically, the display 121 may display the camera switch button for switching the recording camera from the standard camera 180 to the wide-angle camera 190 and the camera switch button for switching the recording camera from the standard camera 180 to the in-camera 200, in place of the camera switch button 330, when the recording camera is the standard camera 180. The display 121 may also display the camera switch button for switching the recording camera from the wide-angle camera 190 to the in-camera 200 and the camera switch button for switching the recording camera from the wide-angle camera 190 to the standard camera 180, in place of the camera switch button 330, when the recording camera is the wide-angle camera 190. The display 121 may also display the camera switch button for switching the recording camera from the in-camera 200 to the standard camera 180 and the camera switch button for switching the recording camera from the in-camera 200 to the wide-angle camera 190, in place of the camera switch button 330, on the display screen 2a when the recording camera is the in-camera 200. When the touch panel 130 detects a predetermined operation on one of the two camera switch buttons, the controller 100 switches the recording camera to the camera corresponding to the camera switch button which has been operated.

The display switch button 340 is an operation button for switching display/non-display of the wide-angle live view image when the standard camera 180 and the wide-angle camera 190 are activated. The display switch button 340 is displayed only when the standard camera 180 and the wide-angle camera 190 are activated. As illustrated in FIG. 6, in the case in which the standard live view image 300 is displayed and the wide-angle live view image is not displayed on the display screen 2a, when the touch panel 130 detects a predetermined operation (e.g., a tap operation) on the display switch button 340, the display 121 displays the wide-angle live view image together with the standard live view image 300 on the display screen 2a. FIG. 7 is a drawing showing an example of a display of the display screen 2a on which the standard live view image 300 and a wide-angle live view image 350 are displayed. In the example in FIG. 7, the standard live view image 300 and the wide-angle live view image 350 are displayed in an upper side and a lower side of the central area 420 in the display screen 2a.

A display position and a display size of the standard live view image 300 and the wide-angle live view image 350 on the display screen 2a are not limited to the example in FIG. 7. For example, the standard live view image 300 and the wide-angle live view image 350 may be displayed side by side in a horizontal direction on the display screen 2a. The standard live view image 300 and the wide-angle live view image 350 may also be displayed so that they partially overlap with each other.

As described above, since the standard live view image 300 taken with the standard camera 180 and the wide-angle live view image 350 taken with the wide-angle camera 190 are displayed together on the display screen 2a, the user can confirm both the object in the standard imaging range 185 taken with the standard camera 180 and the object in the wide-angle imaging range 195 taken with the wide-angle camera 190.

In the meanwhile, in the case in which the standard live view image 300 and the wide-angle live view image 350 are displayed on the display screen 2a, when the touch panel 130 detects a predetermined operation on the display switch button 340, the display 121 hides the wide-angle live view image 350. Then, as illustrated in FIG. 6, the standard live view image 300 is displayed in the central area 420 on the display screen 2a.

The wide-angle camera 190 outputs the captured image to the controller 100 as long as the wide-angle camera 190 is supplied with the power source and thereby activated regardless of the display/non-display of the wide-angle live view image 350 on the display screen 2a. The controller 100 stores the image taken with the wide-angle camera 190 in the volatile memory of the storage 103.

In the case in which the capturing mode of the electronic apparatus 1 is the still image capturing mode, the operation button 310 functions as a shutter button. In the meanwhile, when the capturing mode of the electronic apparatus 1 is the video capturing mode, the operation button 310 functions as an operation button to start or stop capturing a video. In the case in which the capturing mode is the still image capturing mode, when the touch panel 130 detects a predetermined operation (e.g., a tap operation) on the operation button 310, the controller 100 stores a still image for recording, which is captured by the recording camera (the standard camera 180 in the example in FIGS. 6 and 7) when the operation button 310 is operated and differs from the live view image, in the non-volatile memory of the storage 103, and makes the display screen 2a display the still image. In the meanwhile, in the case in which the capturing mode of the electronic apparatus 1 is the video capturing mode, when touch panel 130 detects a predetermined operation (e.g., a tap operation) on the operation button 310, the controller 100 starts storing a video for recording, which is captured by the recording camera and differs from the live view image, in the non-volatile memory of the storage 103. After that, when the touch panel 130 detects a predetermined operation on the operation button 310, the controller 100 stops storing a video for recording, which is captured by the recording camera, in the non-volatile memory of the storage 103.

The operation mode of the recording camera differs among when a still image for recording is captured, when a video for recording is captured, and when a live view image is captured. Thus, for example, the number of pixels of an image captured and an exposure time differ among the operation modes when the still image for recording is captured, when the video for recording is captured, and when the live view image is captured. For example, a still image for recording has more pixels than a live view image.

After Step S3, in Step S4, the controller 100 determines whether or not there is a moving object moving in the wide-angle imaging range 195. Specifically, for example, the controller 100 performs image processing, such as a detection of a moving object based on an inter-frame difference, on a series of input images continuously entered at a predetermined frame rate from the wide-angle camera 190, to thereby detect the position of the moving object in each input image. For example, the central coordinates of an area of each input image in which the moving object is located are detected as the position of the moving object. Used in the processing of detecting the position of the moving object, for example, is a wide-angle live view image 350 which is output from the wide-angle camera 190 and stored in the volatile memory of the storage 103. As described above, the controller 100 functions as a detector of detecting the position of the moving object which moves in the wide-angle imaging range 195. If the controller 100 detects the moving object in the wide-angle live view image 350, the controller 100 determines that there is the moving object in the wide-angle imaging range 195. In the meanwhile, if the controller 100 does not detect the moving object in the wide-angle live view image 350, the controller 100 determines that there is no moving object in the wide-angle imaging range 195.

If the controller 100 determines in Step S4 that there is no moving object in the wide-angle imaging range 195, Step S4 is executed again. In other words, the process of detecting the moving object is executed every predetermined period of time until the controller 100 determines in Step S4 that there is the moving object in the wide-angle imaging range 195.

In the meanwhile, if the controller 100 determines in Step S4 that there is the moving object in the wide-angle imaging range 195, Step S5 is executed. In Step S5, the controller 100 determines whether or not there is the moving object detected in Step S4 is in the standard imaging range 185. Specifically, the controller 100 determines whether or not the position of the moving object in the wide-angle live view image 350 (a central coordinate of the moving object, for example) detected in Step S4 is located in a partial area corresponding to the standard imaging range 185 in the wide-angle live view image 350. In other words, the controller 100 determines whether or not the position of the moving object in the wide-angle live view image 350 detected in Step S4 is located in a partial area where the object appears in the standard imaging range 185 in the wide-angle live view image 350. Then, if the position of the moving object in the wide-angle live view image 350 detected in Step S4 is located in the partial area corresponding to the standard imaging range 185 in the wide-angle live view image 350, the controller 100 determines that there is the moving object in the standard imaging range 185. In the meanwhile, if the position of the moving object in the wide-angle live view image 350 detected in Step S4 is not located in the partial area corresponding to the standard imaging range 185 in the wide-angle live view image 350, the controller 100 determines that there is no moving object in the standard imaging range 185. As described above, the controller 100 functions as a determination units of determining whether or not there is the moving object in the standard imaging range 185. Since the determination of whether or not there is the moving object, which is determined to be located in the wide-angle imaging range 195 in Step S4, in the standard imaging range 185 is performed in Step S5, the controller 100 is also deemed to function as the determination unit of determining whether or not the moving object is located outside the standard imaging range 185 and inside the wide-angle imaging range 195.

If the controller 100 determines in Step S5 that there is no moving object in the standard imaging range 185, that is to say, the moving object is located outside the standard imaging range 185 and inside the wide-angle imaging range 195, Step S6 is executed. In Step S6, the controller 100 estimates an approach area through which the moving object passes at a time of entering the standard imaging range 185 in a periphery of the standard imaging range 185 based on the position of the moving object detected in Step S4.

Described hereinafter using the wide-angle live view image 350 illustrated in FIG. 8 is an operation of estimating the approach area in the periphery of the standard imaging range 185. FIG. 8 separately illustrates a partial area (the partial area where the object appears in the standard imaging range 185) 351 corresponding to the standard imaging range 185 in the wide-angle live view image 350 (an image where the object appears in the wide-angle imaging range 195) for convenience of description. FIG. 8 illustrates a surrounding area other than the partial area 351 in the wide-angle live view image 350 (an area outside the standard imaging range and corresponding to the wide-angle imaging range 195) to be separated into a plurality of areas. Specifically, the surrounding area is separated into an upper area 352, a lower area 353, a left area 354, and a right area 355 by four lines connecting four vertexes located on an upper left, an upper right, a lower right, and a lower left of the wide-angle live view image 350 and four vertexes located on an upper left, an upper right, a lower right, and a lower left of the partial area 351, respectively. An upper edge 356a, a lower edge 356b, a left edge 356c, and a right edge 356d constituting a periphery 356 of the partial area 351 are in contact with the upper area 352, the lower area 353, the left area 354, and the right area 355 in the wide-angle live view image 350, respectively. The upper edge 356a, the lower edge 356b, the left edge 356c, and the right edge 356d of the partial area 351 correspond to an upper edge, a lower edge, a left edge, and a right edge constituting the periphery of the standard imaging range 185. In the example in FIG. 8, a moving object 500 (a train, for example) moving in a left direction appears in the right area 355 in the wide-angle live view image 350.

In Step S6, the controller 100 determines which area the moving object 500 detected in Step S4 is located in the upper area 352, the lower area 353, the left area 354, and the right area 355 in the wide-angle live view image 350. Next, the controller 100 specifies the edge being in contact with the area, which is determined to be the area where the moving object 500 is located, in the upper edge 356a, the lower edge 356b, the left edge 356c, and the right edge 356d of the partial area 351 in the wide-angle live view image 350. Then, the controller 100 estimates that the edge, which corresponds to the edge specified in the partial area 351, in the upper edge, the lower edge, and left edge, and the right edge constituting the periphery of the standard imaging range 185 is the approach area through which the moving object 500 passes at the time of entering the standard imaging range 185. As described above, the controller 100 functions as an estimation unit of estimating the approach area through which the moving object 500 passes at the time of entering the standard imaging range 185 in the periphery of the standard imaging range 185 based on the position of the detected moving object 500.

If the wide-angle live view image 350 illustrated in FIG. 8 is obtained, the controller 100 determines that the moving object 500 is located in the right area 355 in the wide-angle live view image 350. Then, the controller 100 estimates that the right edge of the standard imaging range 185 is the approach area through which the moving object 500 passes at the time of entering the standard imaging range 185.

When the approach area through which the moving object 500 passes at the time of entering the standard imaging range 185 is estimated in Step S6, Step S7 is executed. In Step S7, the display 121 displays first notification information for notifying the approach area estimated in Step S6 on the display screen 2a together with the standard live view image 300.

FIG. 9 is a drawing showing an example of a display of the display screen 2a displaying the first notification information. FIG. 9 illustrates an example of the display of the display screen 2a in the case where the right edge of the standard imaging range 185 is estimated to be the approach area. As illustrated in FIG. 9, a first marker 360 as the first notification information is displayed in a portion corresponding to the right edge of the standard imaging range 185 in the display screen 2a, specifically, in a right end portion 420d of the central area 420 in which the standard live view image 300 is displayed on the display screen 2a to overlap with a right end portion of the standard live view image 300. In the example in FIG. 9, the first marker 360 is a rod-like graphic extending in a vertical direction in the right end portion 420d of the central area 420. The first marker 360 has a color easily distinguished from the standard live view image 300, for example.

If the wide-angle live view image 350 where the moving object 500 moving in the right direction appears in the left area 354 as illustrated in FIG. 10 is obtained, the controller 100 determines that there is the moving object 500 in the left area 354 in the wide-angle live view image 350. Next, the controller 100 estimates that the left edge of the standard imaging range 185 is the approach area through which the moving object 500 passes at the time of entering the standard imaging range 185. Then, the display 121 displays first notification information for notifying the estimated approach area on the display screen 2a together with the standard live view image 300.

FIG. 11 illustrates an example of the display of the display screen 2a displaying the first notification information in the case where the left edge of the standard imaging range 185 is estimated to be the approach area. As illustrated in FIG. 11, the first marker 360 as the first notification information is displayed in a portion corresponding to the left edge of the standard imaging range 185 in the display screen 2a, specifically, in a left end portion 420c of the central area 420 in which the standard live view image 300 is displayed in the display screen 2a to overlap with a left end portion of the standard live view image 300. In the example in FIG. 11, the first marker 360 is a rod-like graphic extending in a vertical direction in the left end portion 429c of the central area 420.

If the wide-angle live view image 350 where a moving object 510 (an aircraft, for example) moving in a lower-right direction appears in the upper area 352 as illustrated in FIG. 12 is obtained, the controller 100 determines that there is the moving object 510 in the upper area 352 in the wide-angle live view image 350. Next, the controller 100 estimates that the upper edge of the standard imaging range 185 is the approach area through which the moving object 510 passes at the time of entering the standard imaging range 185. Then, the display 121 displays first notification information for notifying the estimated approach area on the display screen 2a together with the standard live view image 300.

FIG. 13 illustrates an example of the display of the display screen 2a displaying the first notification information in the case where the upper edge of the standard imaging range 185 is estimated to be the approach area. As illustrated in FIG. 13, the first marker 360 as the first notification information is displayed in a portion corresponding to the upper edge of the standard imaging range 185 in the display screen 2a, specifically, in an upper end portion 420a of the central area 420 in which the standard live view image 300 is displayed on the display screen 2a to overlap with an upper end portion of the standard live view image 300. In the example in FIG. 13, the first marker 360 is a rod-like graphic extending in a vertical direction in the upper end portion 420a of the central area 420.

If the wide-angle live view image 350 where the moving object 500 moving in an upper-left direction appears in the lower area 353 as illustrated in FIG. 14 is obtained, the controller 100 determines that there is the moving object 500 in the lower area 353 in the wide-angle live view image 350. Next, the controller 100 estimates that the lower edge of the standard imaging range 185 is the approach area through which the moving object 500 passes at the time of entering the standard imaging range 185. Then, the display 121 displays first notification information for notifying the estimated approach area on the display screen 2a together with the standard live view image 300.

FIG. 15 illustrates an example of the display of the display screen 2a displaying the first notification information in the case where the lower edge of the standard imaging range 185 is estimated to be the approach area. As illustrated in FIG. 15, the first marker 360 as the first notification information is displayed in a portion corresponding to the lower edge of the standard imaging range 185 in the display screen 2a, specifically, in a lower end portion 420b of the central area 420 in which the standard live view image 300 is displayed in the display screen 2a to overlap with a lower end portion of the standard live view image 300. In the example in FIG. 15, the first marker 360 is a rod-like graphic extending in a vertical direction in the lower end portion 420b of the central area 420.

As described above, if the moving object is determined to be located outside the standard imaging range 185 and inside the wide-angle imaging range 195, the controller 100 estimates the approach area through which the moving object passes at the time of entering the standard imaging range 185. The display 121 displays first notification information for notifying the estimated approach area on the display screen 2a together with the standard live view image 300. The user can thereby recognize that there is the moving object outside the standard imaging range 185 and inside the wide-angle imaging range 195 and which area the moving object enters from at the time of entering the standard imaging range 185. Accordingly, the user can easily capture the moving object entering the standard imaging range 185 by operating the operation button 310 while viewing the first notification information and the standard live view image 300.

The display 121 displays the first marker 360 as the first notification information in a portion corresponding to the approach area, through which the moving object is estimated to pass at the time of entering the standard imaging range 185, in the display screen 2a on which the standard live view image 300 is displayed. Accordingly, the user can recognize which area the moving object, which enters the standard imaging range 185 from the wide-angle imaging range 195, enters from in the standard imaging range 185 more intuitively.

Since the first marker 360 is displayed to overlap with the end portion of the standard live view image 300, a state where the standard live view image 300 is hardly seen due to the first marker 360 can be reduced.

When the first marker 360 is displayed to overlap with the standard live view image 300, the first marker 360 may be a marker through which the standard live view image 300 located below the first marker 360 can be transparently seen instead of a marker through which the standard live view image 300 located below the first marker 360 cannot be seen.

After the first notification information is displayed on the display screen 2a in Step S7, the process subsequent to Step S4 is executed again. Accordingly, the display 121 continuously displays the first marker 360 in the right end portion 420d of the central area 420 in which the standard live view image 300 is displayed on the display screen 2a while the controller 100 determines that the moving object is located in the right area 355 in the wide-angle live view image 350, for example.

If the moving object 500 illustrated in FIG. 8 further moves in the left direction, the moving object 500 is then located in the standard imaging range 185. FIG. 16 is a drawing showing an example of the wide-angle live view image 350 when the moving object 500 is located in the standard imaging range 185. In the example in FIG. 16, the moving object 500 is located in the partial area 351 corresponding to the standard imaging range 185 in the wide-angle live view image 350. In the above case, the controller 100 determines that there is the moving object 500 in the standard imaging range 185 in Step S5 illustrated in FIG. 5.

If the controller 100 determines in Step S5 that there is the moving object 500 in the standard imaging range 185, Step S8 is executed. In Step S8, the display 121 displays second notification information indicating that there is the moving object 500 in the standard imaging range 185 on the display screen 2a together with the standard live view image 300. FIG. 17 is a drawing showing an example of a display of the display screen 2a displaying the second notification information. Displayed in the example in FIG. 17 is a second marker 370 having a frame shape for bordering a peripheral edge of the central area 420 in the display screen 2a. The second marker 370 is displayed to overlap with a peripheral edge of the standard live view image 300, for example. The second marker 370 has a color easily distinguished from the standard live view image 300, for example. When the second marker 370 is displayed to overlap with the standard live view image 300, the second marker 370 may be a marker through which the standard live view image 300 located below the second marker 370 can be transparently seen instead of a marker through which the standard live view image 300 located below the second marker 370 cannot be seen.

As described above, if it is determined that there is the moving object 500 in the standard imaging range 185, the display 121 displays the second notification information for notifying that there is the moving object 500 in the standard imaging range 185 on the display screen 2a together with the standard live view image 300. Accordingly, the user can easily confirm that there is the moving object 500 in the standard imaging range 185. When the electronic apparatus 1 operates in the still image capturing mode, the user can record the still image where the moving object 500 appears in the storage 103 by operating the operation button 310 at a time of visually confirming the second notification information. The user can thereby easily capture the moving object 500 at an appropriate timing when there is the moving object 500 in the standard imaging range 185.

After the second notification information is displayed in Step S8, the process subsequent to Step S4 is executed again. Accordingly, the display 121 continuously displays the second notification information while the controller 100 determines that there is the moving object 500 in the standard imaging range 185.

If the moving object 500 illustrated in FIG. 16 further moves in the left direction, the position of the moving object 500 is located outside the standard imaging range 185. FIG. 18 is a drawing showing an example of the wide-angle live view image 350 when the moving object 500 moves out of the standard imaging range 185. In the example in FIG. 18, the moving object 500 moving in the left direction is located in the left area 354 in the wide-angle live view image 350. In the above case, the controller 100 determines that there is no moving object 500 in the standard imaging range 185 in Step S5 illustrated in FIG. 5. Next, the controller 100 determines that the moving object 500 is located in the left area 354 in the wide-angle live view image 350 in Step S6. Then, the controller 100 estimates that the left edge of the standard imaging range 185 is the approach area through which the moving object 500 passes at the time of entering the standard imaging range 185.

In the present example, the controller 100 estimates the approach area through which the moving object passes at the time of entering the standard imaging range 185 based on the detection result of the position of the moving object without detecting the moving direction of the moving object. Thus, even if the moving object 500 does not move toward the standard imaging range 185 as illustrated in FIG. 18, the controller 100 estimates the approach area on an assumption that the moving object 500 moves from the position where the moving object 500 has been detected toward the standard imaging range 185. Then, the display 121 displays the first notification information illustrated in FIG. 11 on the display screen 2a together with the standard live view image 300.

The controller 100 may also detect the moving direction of the moving object to estimate the approach area through which the moving object passes at the time of entering the standard imaging range 185 based on the moving direction and the position of the moving object. In the above case, the estimation of the approach area can be performed only on the moving object moving from the wide-angle imaging range 195 toward the standard imaging range 185 in the moving objects moving in the wide-angle imaging range 195. The operation of the electronic apparatus 1 in the above case is described in detailed in a modification example described below.

If the moving object 500 illustrated in FIG. 18 further moves to the left, the moving object 500 is located outside the wide-angle imaging range 195. In the above case, the controller 100 determines that there is no moving object 500 in the wide-angle imaging range 195 in Step S4 illustrated in FIG. 5. The display 121 does not display the first notification information and the second notification information on the display screen 2a while the controller 100 determines that there is no moving object 500 in the wide-angle imaging range 195.

Described in the example above is the display example of the first and second notification information in the case where the standard live view image 300 is displayed and the wide-angle live view image 350 is not displayed on the display screen 2, however, the first and second notification information is displayed even in the case where the standard live view image 300 and the wide-angle live view image 350 are displayed on the display screen 2a.

FIG. 19 is a drawing showing an example of a display of the display screen 2a on which the first notification information is displayed when the standard live view image 300 and the wide-angle live view image 350 are displayed together. Displayed in the example in FIG. 19 is the first notification information for notifying that the right edge of the standard imaging range 185 is the approach area. In the example in FIG. 19, the first marker 360 as the first notification information is displayed in a portion corresponding to the estimated approach area (the right edge of the standard imaging range 185) in the area around the standard live view image 300 in the display screen 2a, specifically, an area 302d located on a right side of the standard live view image 300. In the example in FIG. 19, the first marker 360 is not displayed to overlap with the standard live view image 300 but displayed outside the standard live view image 300.

As described above, the display 121 displays the first notification information indicating the approach area through which the moving object is estimated to pass at the time of entering the standard imaging range 185 on the display screen 2a, on which the standard live view image 300 is displayed, together with the wide-angle live view image 350 where the moving object appears. The user can thereby easily confirm the approach area through which the moving object passes at the time of entering the standard imaging range 185 from the wide-angle imaging range 195.

FIG. 20 is a drawing showing an example of a display of the display screen 2a on which the second notification information is displayed when the standard live view image 300 and the wide-angle live view image 350 are displayed together. Displayed in the example in FIG. 20 is the second marker 370 having the frame shape to surround a periphery of the standard live view image 300.

The first notification information displayed by the display 121 may be another graphic instead of the rod-like first marker 360. For example, the first notification information maybe a graphic 361 of an arrow shape displayed in an end portion of the standard live view image 300 as illustrated in FIG. 21. The graphic 361 notifies which area in the standard imaging range 185 the moving object enters from by a position where the graphic 361 is displayed and a direction of the arrow. In the example in FIG. 21, the graphic 361 of the arrow shape pointing to the left for notifying that the right edge of the standard imaging range 185 is the approach area is displayed to overlap with the right end portion of the standard live view image 300.

FIG. 22 is a drawing showing an example of a display of the display screen 2a on which the graphic 361 as the first notification information is displayed when the standard live view image 300 and the wide-angle live view image 350 are displayed together. Displayed in the example in FIG. 22 is the graphic 361 for notifying that the right edge of the standard imaging range 185 is the approach area. In the example in FIG. 22, the graphic 361 as the first notification information is displayed in a portion corresponding to the estimated approach area (the right edge of the standard imaging range 185) in the area around the standard live view image 300 on the display screen 2a, specifically, an area located on a right side of the standard live view image 300. In the example in FIG. 22, the graphic 361 is not displayed to overlap with the standard live view image 300 but displayed outside the standard live view image 300.

The first notification information may be a character indicating the estimated approach area. The second notification information may be another graphic or character instead of the graphic of frame shape for bordering the peripheral edge of the standard live view image 300 or the graphic of frame shape for surrounding the standard live view image 300. The first and second notification information may be displayed in a portion other than the end portion of the central area 420 or a portion around the standard live view image 300. For example, the character as the first notification information or the character as the second notification information may be displayed to overlap with a central portion of the standard live view image 300.

If there are a plurality of moving objects moving in the wide-angle imaging range 195, the process of Steps S4 to S8 illustrated in FIG. 5 is individually executed for each moving object. FIG. 23 is a drawing showing an example of the wide-angle live view image 350 where the two moving objects 500 and 510 appear. In the example in FIG. 23, the moving object 500 moving in the left direction appears in the right area 355 in the wide-angle live view image 350. The moving object 510 moving in the upper right direction appears in the left area 354 in the wide-angle live view image 350. If the wide-angle live view image 350 illustrated in FIG. 23 is obtained, the controller 100 estimates that the right edge of the standard imaging range 185 is the approach area through which the moving object 500 passes at the time of entering the standard imaging range 185. The controller 100 estimates that the left edge of the standard imaging range 185 is the approach area through which the moving object 510 passes at the time of entering the standard imaging range 185. Then, the display 121 displays the two pieces of the first notification information for notifying the approach areas estimated for each of the moving objects 500 and 510.

FIG. 24 is a drawing showing an example of a display of the display screen 2a displaying the two pieces of the first notification information. In the example in FIG. 24, the first marker 360 for notifying that the right edge of the standard imaging range 185 is the approach area of the moving object 500 is displayed in the right end portion 420d of the central area 420 in which the standard live view image 300 is displayed to overlap with the right end portion of the standard live view image 300. A first marker 362 for notifying that the left edge of the standard imaging range 185 is the approach area of the moving object 510 is displayed in the left end portion 429c of the central area 420 in which the standard live view image 300 is displayed to overlap with the left end portion of the standard live view image 300. The first marker 360 and the first marker 362 are displayed so that each of them can be distinguishingly recognized. For example, the first marker 360 and the first marker 362 are displayed in different colors.

If the approach areas through which the plurality of moving objects are estimated to pass at the time of entering the standard imaging range 185 are the same portions, the plurality of pieces of the first notification information for the plurality of moving objects may be displayed in the portion corresponding to the same portions in the display screen 2a.

For example, if the wide-angle live view image where the moving objects 500 and 510 appear in the right area 355 illustrated in FIG. 25 is obtained, the controller 100 determines that the moving objects 500 and 510 are located in the right area in the wide-angle live view image 350. Next, the controller 100 estimates that the right edge of the standard imaging range 185 is the approach area through which each of the moving objects 500 and 510 passes at the time of entering the standard imaging range 185. Then, the display 121 displays the first notification information for notifying the approach area for each of the moving objects 500 and 510 on the display screen 2a together with the standard live view image 300.

FIG. 26 illustrates an example of the display of the display screen 2a displaying the pieces of the first notification information in the case where the right edge of the standard imaging range 185 is estimated to be the approach area of the moving objects 500 and 510. As illustrated in FIG. 26, the first marker 360 for notifying the approach area with regard to the moving object 500 is displayed in the right end portion 420d of the central area 420 in which the standard live view image 300 is displayed in the display screen 2a. The first marker 362 for notifying the approach area with regard to the moving object 510 is displayed in an area 420e located inside the right end portion 420d in the central area 420 in which the standard live view image 300 is displayed in the display screen 2a.

In the example above, the approach area through which the moving object passes at the time of entering the standard imaging range 185 in the periphery of the standard imaging range 185 is estimated from four portions in the periphery of the standard imaging range 185 divided into four, however, the approach area may also be estimated from portions in the periphery of the standard imaging range 185 divided into a plurality of portions larger than four in number.

FIG. 27 is a diagram showing an example of the wide-angle live view image 350 indicating an area other than the partial area 351 corresponding to the standard imaging range 185 (an area outside the standard imaging range 185 and corresponding to the wide-angle imaging range 195) divided into eight. In the example in FIG. 27, each of the upper area 352, the lower area 353, the left area 354, and the right area 355 in the wide-angle live view image 350 illustrated in FIG. 8 is further divided into two areas in a circumferential direction. The upper area 352, the lower area 353, the left area 354, and the right area 355 in the wide-angle live view image 350 are divided into the two areas by straight lines connecting each midpoint of the upper edge, the lower edge, the left edge, and the right edge of the wide-angle live view image 350 and each midpoint of the upper edge 356a, the lower edge 356b, the left edge 356c, and the right edge 356d of the partial area 351, respectively. The upper area 352 and the lower area 353 in the wide-angle live view image 350 may be divided into two areas by straight lines passing through the midpoint of the upper edge 356a and the midpoint of the lower edge 356b of the partial area 351, respectively, for example, and the left area 354 and the right area 355 in the wide-angle live view image 350 may be divided into two areas by straight lines passing through the midpoint of the left edge 356c and the midpoint of the right edge 356d of the partial area 351, respectively, for example.

In the example in FIG. 27, the area other than the partial area 351 in the wide-angle live view image 350 is divided into eight areas of an upper left area 352a, an upper right area 352b, a lower left area 353a, a lower right area 353b, an upper left area 354a, a lower left area 354b, an upper right area 355a, and a lower right area 355b. An upper left edge portion 356aa, an upper right edge portion 356ab, a lower left edge portion 356ba, a lower right edge portion 356bb, an upper left edge portion 356ca, a lower left edge portion 356cb, an upper right edge portion 356da, and a lower right edge portion 356db constituting the periphery 356 of the partial area 351 are in contact with the upper left area 352a, the upper right area 352b, the lower left area 353a, the lower right area 353b, the upper left area 354a, the lower left area 354b, the upper right area 355a, and the lower right area 355b in the wide-angle live view image 350, respectively. The upper left edge portion 356aa, the upper right edge portion 356ab, the lower left edge portion 356ba, the lower right edge portion 356bb, the upper left edge portion 356ca, the lower left edge portion 356cb, the upper right edge portion 356da, and the lower right edge portion 356db of the partial area 351 correspond to an upper left edge portion, an upper right edge portion, a lower left edge portion, a lower right edge portion, an upper left edge portion, a lower left edge portion, an upper right edge portion, and a lower right edge portion constituting the periphery of the standard imaging range 185, respectively. In the example in FIG. 27, the moving object 500 moving in the left direction appears in the lower right area 355b in the wide-angle live view image 350.

The controller 100 determines in Step S6 illustrated in FIG. 5 which area the moving object detected in Step S4 is located, the upper left area 352a, the upper right area 352b, the lower left area 353a, the lower right area 353b, the upper left area 354a, the lower left area 354b, the upper right area 355a, or the lower right area 355b in the wide-angle live view image 350. Next, the controller 100 specifies a portion being in contact with the area, in which the moving object is determined to be located, in the upper left edge portion 356aa, the upper right edge portion 356ab, the lower left edge portion 356ba, the lower right edge portion 356bb, the upper left edge portion 356ca, the lower left edge portion 356cb, the upper right edge portion 356da, and the lower right edge portion 356db of the partial area 351 in the wide-angle live view image 350. Then, the controller 100 estimates that the portion corresponding to the portion specified in the partial area 351 in the upper left edge portion, the upper right edge portion, the lower left edge portion, the lower right edge portion, the upper left edge portion, the lower left edge portion, the upper right edge portion, and the lower right edge portion constituting the periphery of the standard imaging range 185 is the approach area through which the moving object passes at the time of entering the standard imaging range 185.

If the wide-angle live view image 350 illustrated in FIG. 27 is obtained, the controller 100 determines that the moving object 500 is located in the lower right area 355b in the wide-angle live view image 350. Then, the controller 100 estimates that the lower right edge portion of the standard imaging range 185 corresponding to the lower right edge portion 356db of the partial area 351 in the wide-angle live view image 350 is the approach area through which the moving object 500 passes at the time of entering the standard imaging range 185. Then, the display 121 displays the first notification information indicating the estimated approach area on the display screen 2a together with the standard live view image 300.

FIG. 28 illustrates an example of the display of the display screen 2a in the case where the lower right edge portion of the standard imaging range 185 is estimated to be the approach area. As illustrated in FIG. 28, the first marker 360 as the first notification information is displayed in a portion corresponding to the lower right edge of the standard imaging range 185 in the display screen 2a, specifically, in a lower portion 420f of the right end portion of the central area 420, in which the standard live view image 300 is displayed, to overlap with a lower portion of the right end portion of the standard live view image 300.

As described above, the approach area through which the moving object passes at the time of entering the standard imaging range 185 is estimated from the portions of the periphery of the standard imaging range 185 divided into eight, and the first notification information indicating the estimated approach area is displayed on the display screen 2a, thus the user can recognize which area in the standard imaging range 185 the moving object 500, which enters the standard imaging range 185 from the wide-angle imaging range 195, enters from more accurately compared with the case where the approach area is estimated from the portions of the periphery of the standard imaging range 185 divided into four.

A total number of divisions and a method of dividing the periphery of the standard imaging range 185 in estimating the approach area through which the moving object passes at the time of entering the standard imaging range 185 are not limited to the example described above.

In the example above, the moving object 500 is the train, and the moving object 510 is the aircraft, however, each moving object is not limited thereto. For example, the moving object may be a human or an animal such as a dog other than the human. FIG. 29 is a drawing showing an example of the wide-angle live view image 350 where a moving object 520 which is a human appears. In the example in FIG. 29, the moving object 520 (the human) moving in the left direction is located in the right area 355 in the wide-angle live view image 350. FIG. 30 is a drawing showing an example of the wide-angle live view image 350 where a moving object 530 which is a dog appears. In the example in FIG. 30, the moving object 530 (the dog) moving in the left direction is located in the right area 355 in the wide-angle live view image 350.

A process similar to the process performed on the moving object 500 (the train) illustrated in FIG. 8 is performed on the moving object 520 illustrated in FIG. 29 and the moving object 530 illustrated in FIG. 30. Specifically, the controller 100 determines that the moving object 520 is located in the right area 355 in the wide-angle live view image 350, and estimates that the right edge of the standard imaging range 185 is the approach area. As illustrated in FIG. 9, the display 121 displays the first marker 360 as the first notification information in the right end portion 420d of the central area 420 in which the standard live view image 300 is displayed in the display screen 2a to overlap with the right end portion of the standard live view image 300. Since the process performed on the moving object 530 is similar to that performed on the moving object 520, the detailed description is omitted.

### VARIOUS MODIFICATION EXAMPLES

The various modification examples are described below.

### First Modification Example

In the example above, the controller 100 estimates the approach area through which the moving object passes at the time of entering the standard imaging range 185 in the periphery of the standard imaging range 185 based on the detection result of the position of the moving object without detecting the moving direction of the moving object. In the present modification example, the controller 100 detects the moving direction of the moving object in addition to the position of the moving object. Then, the controller 100 estimates the approach area through which the moving object passes at the time of entering the standard imaging range 185 in the periphery of the standard imaging range 185 based on the position and the moving direction of the detected moving object.

FIG. 31 is a flow chart illustrating an example of an operation of the electronic apparatus 1 according to the present modification example. Since the processing in Steps S11 to S13 is similar to that in Steps S1 to S3 illustrated in FIG. 5, the description is omitted.

After the process in Steps S11 to S13, in Step S14, the controller 100 performs image processing, such as a detection of a moving object based on an inter-frame difference, for example, on a series of input images continuously entered at a predetermined frame rate from the wide-angle camera 190, to thereby detect the position and the moving direction of the moving object in each input image. The wide-angle live view image 350, for example, is used in the image processing. As described above, the controller 100 functions as a detector of detecting the position and moving direction of the moving object which moves in the wide-angle imaging range 195. If the controller 100 detects the moving object in the wide-angle live view image 350, the controller 100 determines that there is the moving object in the wide-angle imaging range 195. In the meanwhile, if the controller 100 does not detect the moving object in the wide-angle live view image 350, the controller 100 determines that there is no moving object in the wide-angle imaging range 195.

If the controller 100 determines in Step S14 that there is no moving object in the wide-angle imaging range 195, Step S14 is executed again. In the meanwhile, if the controller 100 determines in Step S14 that there is the moving object in the wide-angle imaging range 195, Step S15 is executed.

If the controller 100 determines in Step S15 that there is the moving object in the standard imaging range 185, Step S18 is executed. In Step S18, the display 121 displays second notification information indicating that there is the moving object in the standard imaging range 185 on the display screen 2a together with the standard live view image 300 as illustrated in FIG. 17.

In the meanwhile, if the controller 100 determines in Step S15 that there is no moving object in the standard imaging range 185, that is to say, the moving object is located outside the standard imaging range 185 and inside the wide-angle imaging range 195, Step S16 is executed. In Step S16, the controller 100 estimates an approach area through which the moving object passes at the time of entering the standard imaging range 185 in the periphery of the standard imaging range 185 based on the position and the moving direction of the moving object detected in Step S14. Specifically, when the moving object goes straight along the detected moving direction from the detected position, the controller 100 specifies which portion of the periphery of the partial area 351 in the wide-angle live view image 350 the moving object passes through to enter the standard imaging range 185.

Described hereinafter using the wide-angle live view image 350 illustrated in FIG. 32 is an operation performed by the controller 100 estimating the approach area in the periphery of the standard imaging range 185 based on the position and the moving direction of the moving object. In the example in FIG. 32, the moving object 500 moving in the left direction appears in the right area 355 in the wide-angle live view image 350. The moving object 510 moving in the upper right direction appears in the left area 354 in the wide-angle live view image 350.

If the wide-angle live view image 350 illustrated in FIG. 32 is obtained, the controller 100 detects the position and a moving direction 500a of the moving object 500 in the wide-angle live view image 350 in Step S14. Next, in Step S16, if the moving object 500 goes straight along the moving direction 500a from the position in which the moving object 500 is detected, the controller 100 determines that the moving object 500 passes through the right edge 356d of the partial area 351 to enter the partial area 351. Then, the controller 100 estimates that the portion corresponding to the right edge 356d of the partial area 351 in the standard imaging range 185 is the approach area through which the moving object 500 passes at the time of entering the standard imaging range 185.

The controller 100 detects the position and a moving direction 510a of the moving object 510 in the wide-angle live view image 350 in Step S14. Next, in Step S16, if the moving object 510 goes straight along the moving direction 510a, the controller 100 determines that the moving object 510 does not pass through the periphery of the partial area 351. If it is determined that the moving object does not pass through the periphery of the partial area 351, the controller 100 does not specify the approach area. As described above, in the present modification example, even if it is determined that there is the moving object outside the standard imaging range 185 and inside the wide-angle imaging range 195, the approach area is not estimated depending on the moving direction of the detected moving object.

Then, in Step S17, the first notification information indicating the approach area with regard to the moving object 500 is displayed on the display screen 2a together with the standard live view image 300 as illustrated in FIG. 9. If the wide-angle live view image 350 illustrated in FIG. 32 is obtained, the approach area with regard to the moving object 510 is not estimated, thus the first notification information on the moving object 510 is not displayed.

As described above, if the moving object is determined to be located outside the standard imaging range 185 and inside the wide-angle imaging range 195, the controller 100 estimates the approach area through which the moving object, which moves toward the standard imaging range 185, passes at the time of entering the standard imaging range 185 based on the position and the moving direction of the detected moving object. Then, the controller 100 makes the display screen 2a display the first notification information indicating the estimated approach area. Accordingly, the user can recognize which area the moving object, which moves toward the standard imaging range 185 from the wide-angle imaging range 195, enters from in the standard imaging range 185 more accurately.

### Second Modification Example

In each example above, when the recording camera is the standard camera 180, the controller 100 constantly operates the wide-angle camera 190 to perform the process of detecting the moving object. In contrast, in the present modification example, the electronic apparatus 1 includes a normal capturing mode in which the wide-angle camera 190 is not operated and the process of detecting the moving object is not thereby performed even when the recording camera is the standard camera 180 and a moving object detection mode in which the wide-angle camera 190 is operated to perform the process of detecting the moving object when the recording camera is the standard camera 180. FIG. 33 is a flow chart illustrating an example of an operation of the electronic apparatus 1 including the normal picturing mode and the moving object detection mode.

As illustrated in FIG. 33, when a camera app is executed in Step S21, the controller 100 supplies a power source to the standard camera 180, for example, in the standard camera 180, the wide-angle camera 190, and the in-camera 200 in Step S22. That is to say, the electronic apparatus 1 operates in the normal capturing mode at the time of activating the camera app. Then, the display 121 displays the standard live view image 300 on the display screen 2a in Step S23. FIG. 34 is a drawing showing an example of a display of the display screen 2a on which the standard live view image 300 is displayed when the electronic apparatus 1 operates in the normal capturing mode. As illustrated in FIG. 34, the wide-angle camera 190 is not activated, thus the display switch button 340 illustrated in FIG. 6 is not displayed. Displayed in the lower end portion 410 of the display screen 2a is a moving object detection switch button 380 for switching the operation mode of the electronic apparatus 1 between the normal capturing mode and the moving object detection mode. The moving object detection switch button 380 is displayed only when the recording camera is the standard camera 180.

In Step S24, in the case in which the operation mode of the electronic apparatus 1 is the normal capturing mode, when touch panel 130 detects a predetermined operation (e.g., a tap operation) on the moving object detection switch button 380, the controller 100 switches the operation mode of the electronic apparatus 1 from the normal capturing mode to the moving object detection mode. When the operation mode of the electronic apparatus 1 is switched from the normal capturing mode to the moving object detection mode, the controller 100 supplies the power source to the wide-angle camera 190 to activate the wide-angle camera 190 in Step S25. Then, the controller 100 starts the process of detecting the moving object indicated in Steps S26 to S30. Since the sequential processing in Steps S26 to S30 is similar to that in Steps S4 to S8 illustrated in FIG. 5, the description is omitted.

In the meanwhile, in the case in which the operation mode of the electronic apparatus 1 is the moving object detection mode, when touch panel 130 detects a predetermined operation on the moving object detection switch button 380, the controller 100 switches the operation mode of the electronic apparatus 1 from the moving object detection mode to the normal capturing mode. When the operation of the electronic apparatus 1 is switched from the moving object detection mode to the normal capturing mode, the controller 100 stops supplying the power source to the wide-angle camera 190 to stop the operation of the wide-angle camera 190. Then, the controller 100 stops the process of detecting the moving object.

As described above, in the case in which the recording camera is the standard camera 180, the wide-angle camera 190 is activated to perform the process of detecting the moving object only when the operation of making the electronic apparatus 1 operate in the moving object detection mode performed by the user is detected, thus a consumed power of the electronic apparatus 1 can be reduced.

### Third Modification Example

In each example above, the controller 100 performs the process of detecting the position or the position and the moving direction of all of the detected moving objects, and performs the process of estimating the approach area. In contrast, in the present modification example, the controller 100 performs those processes only on a moving object to be targeted (also referred to as the target moving object hereinafter). For example, the processes are performed only on a specified moving object (for example, a specified person) or a specified type of moving object (for example, all of a plurality of moving objects detected as the human).

FIG. 35 is a flow chart illustrating an example of an operation of the electronic apparatus 1 according to the present modification example. Since the processing in Steps S31 to S33 is similar to that in Steps S1 to S3 illustrated in FIG. 5, the description is omitted.

After the process in Steps S31 to S33, in Step S34, the controller 100 performs image processing, such as a template matching, for example, on a series of input images continuously entered at a predetermined frame rate from the wide-angle camera 190, to thereby detect the position of the target moving object in each input image. When the target moving object is the human, a well-known face recognition technique is used, for example. The target moving object is preset by the user, and information indicating the target moving object is stored in the storage 103. Specifically, a reference image for detecting the target moving object is taken with the standard camera 180 in advance, for example, and stored in the non-volatile memory in the storage 103. The wide-angle live view image 350, for example, is used in the process of detecting the target moving object. Then, the controller 100 detects the position of the partial area corresponding to the reference image which indicates the target moving object in the wide-angle live view image 350, thereby detecting the position of the target moving object. As described above, the controller 100 functions as a detector of detecting the position of the target moving object located in the wide-angle imaging range 195. Then, if the controller 100 detects the target moving object in the wide-angle live view image 350, the controller 100 determines that there is the target moving object in the wide-angle imaging range 195. In the meanwhile, if the controller 100 does not detect the target moving object in the wide-angle live view image 350, the controller 100 determines that there is no target moving object in the wide-angle imaging range 195.

If the controller 100 determines in Step S34 that there is the target moving object in the standard imaging range 185, Step S34 is executed again. In the meanwhile, if the controller 100 determines in Step S34 that there is the target moving object in the wide-angle imaging range 195, Step S35 is executed.

In Step S35, the controller 100 determines whether or not there is the target moving object detected in Step S34 is in the standard imaging range 185. Specifically, the controller 100 determines whether or not the position of the target moving object in the wide-angle live view image 350 (a central coordinate of the target moving object, for example) detected in Step S34 is located in the partial area 351 in the wide-angle live view image 350. Then, if the position of the target moving object in the wide-angle live view image 350 detected in Step S34 is located in the partial area 351 in the wide-angle live view image 350, the controller 100 determines that there is the target moving object in the standard imaging range 185. Then, if the position of the target moving object in the wide-angle live view image 350 detected in Step S34 is not located in the partial area 351 in the wide-angle live view image 350, the controller 100 determines that there is no target moving object in the standard imaging range 185. As described above, the controller 100 functions as a determination unit of determining whether or not there is the target moving object in the standard imaging range 185. Since the determination of whether or not there is the target moving object, which is determined to be located in the wide-angle imaging range 195 in Step S34, in the standard imaging range 185 is performed in Step S35, the controller 100 is also deemed to function as the determination unit of determining whether or not the target moving object is located outside the standard imaging range 185 and inside the wide-angle imaging range 195.

If the controller 100 determines in Step S35 that there is no target moving object in the standard imaging range 185, that is to say, the target moving object is located outside the standard imaging range 185 and inside the wide-angle imaging range 195, Step S36 is executed. In Step S36, the controller 100 estimates the approach area through which the target moving object passes at the time of entering the standard imaging range 185 in a periphery of the standard imaging range 185 based on the position of the target moving object detected in Step S34.

Described hereinafter using the wide-angle live view image 350 illustrated in FIG. 36 is an operation of estimating the approach area in the periphery of the standard imaging range 185 with regard to the target moving object. In the present example, the standard imaging range 185 is smaller than that in a case where the standard camera 180 has the zoom magnification “one” due to the zoom-in function of the standard camera 180. Thus, the range of the partial area 351 illustrated in FIG. 36 is smaller than the partial area 351 illustrated in FIG. 8, for example. Although a case where the zoom-in function of the standard camera 180 operates is described in the present example, the zoom magnification of the standard camera 180 may remain “one”.

In the example in FIG. 36, the moving object 520 and a moving object 521 moving in the left direction appear in the right area 355 in the wide-angle live view image 350. In the example in FIG. 36, the moving object 520 and the moving object 521 are humans. In the present example, a face of the moving object 520 is set as the target moving object. A partial area 357 where the face of the moving object 520 appears in the wide-angle live view image 350 is detected as a portion corresponding to the target moving object as illustrated in FIG. 36.

If the wide-angle live view image 350 illustrated in FIG. 36 is obtained, the controller 100 determines that the face of the moving object 520 which is the target object is located in the right area 355 in the wide-angle live view image 530 in Step S36. Then, the controller 100 estimates that the right edge of the standard imaging range 185 is the approach area through which the face of the moving object 520 passes at the time of entering the standard imaging range 185. In the meanwhile, since the moving object 521 is not the target moving object, the process of detecting the position and the process of estimating the approach area are not performed on the moving object 521.

When the approach area through which the target moving object passes at the time of entering the standard imaging range 835 is estimated in Step S36, Step S37 is executed. The display 121 displays the display screen 2a illustrated in FIG. 37 in Step S37. In the example in FIG. 37, the first marker 360 as the first notification information indicating the approach area with regard to the target moving object is displayed in the right end portion 420d of the central area 420 in which the standard live view image 300 is displayed in the display screen 2a. Since the approach area with regard to the moving object 521 is not estimated, the first notification information on the moving object 521 is not displayed on the display screen 2a.

As described above, the controller 100 estimates the approach area through which the moving object to be targeted, in the plurality of moving objects, passes at the time of entering the standard imaging range 185, and makes the display screen 2a display the first notification information indicating the estimated approach area. Accordingly, the user can capture the moving object to be targeted more easily.

If the moving objects 500 and 521 illustrated in FIG. 36 further move in the left direction, the moving object 521 is located in the standard imaging range 185, and the moving object 520 remains in the right area 355 in the wide-angle live view image 350. FIG. 38 is a drawing showing an example of the wide-angle live view image 350 when the moving object 521 is located in the standard imaging range 185 and the moving object 520 is located in the right area 355 in the wide-angle live view image 350. In the example in FIG. 38, the moving object 521 is located in the partial area 351 corresponding to the standard imaging range 185 in the wide-angle live view image 350. If the wide-angle live view image 350 illustrated in FIG. 38 is obtained, the display 121 displays the display screen 2a illustrated in FIG. 39. In the example in FIG. 39, the moving object 521 appears in the standard live view image 300. Even in such a case, the detection of the position is not performed on the moving object 521, thus the second notification information on the moving object 521 is not displayed on the display screen 2a. As illustrated in FIG. 38, the face of the moving object 520 which is the target moving object remains in the right area 355 in the wide-angle live view image 350, thus the first marker 360 as the first notification information on the face of the moving object 520 is kept displayed in the right end portion 420d of the central area 420 in which the standard live view image 300 is displayed in the display screen 2a.

If the moving objects 500 and 521 illustrated in FIG. 38 further move in the left direction, the moving object 521 is located outside the standard imaging range 185, and the face of the moving object 520 is located in the standard imaging range 185. FIG. 40 is a drawing showing an example of the wide-angle live view image 350 when the moving object 520 is located in the standard imaging range 185 and the moving object 521 is located in the right area 354 in the wide-angle live view image 350. In the example in FIG. 40, the moving object 520 is located in the partial area 351 corresponding to the standard imaging range 185 in the wide-angle live view image 350. In the above case, the controller 100 determines that there is the target moving object (the face of the moving object 520) in the standard imaging range 185 in Step S35 illustrated in FIG. 35.

If the controller 100 determines in Step S35 that there is the moving object in the standard imaging range 185, Step S38 is executed. The display 121 displays the display screen 2a illustrated in FIG. 41 in Step S38. In the example in FIG. 41, the second marker 370 as the second notification information indicating that there is the target moving object in the standard imaging range 185 is displayed to border the peripheral edge of the central area 420 in the display screen 2a. The display 121 displays a third marker 390 for identifying the target moving object in a portion corresponding to the partial area 357 in the display screen 2a.

As described above, even if the plurality of moving objects appear in the wide-angle imaging range 195, the display 121 displays the second notification information for notifying that there is the moving object to be targeted in the standard imaging range 185 on the display screen 2a together with the standard live view image 300 if it is determined that there is the moving object to be targeted in the standard imaging range 185. Accordingly, the user can capture the moving object to be targeted more easily.

Since the position of the target moving object is detected in the present example, the controller 100 may focus the standard camera 180 on the moving object if the controller 100 determines that there is the target moving object in the standard imaging range 185. Accordingly, the user can capture the moving object to be targeted more easily.

In each example above, if the controller 100 determines that there is the moving object in the standard imaging range 185, the display 121 displays the second notification information for notifying that there is the moving object in the standard imaging range 185 on the display screen 2a together with the standard live view image 300, however, the display 121 needs not display the second notification information even if it is determined that there is the moving object in the standard imaging range 185. Even in a case where the display 121 does not display the second notification information when it is determined that there is the moving object in the standard imaging range 185, the user can recognize, as described above, that the moving object is located outside the standard imaging range 185 and inside the wide-angle imaging range 195 and which area the moving object enters from at the time or entering the standard imaging range 185 from the first notification information displayed on the display screen 2a before the moving object enters the standard imaging range 185. Even when the second notification information is not displayed, the user can confirm that the moving object is in the standard imaging range 185 by viewing the moving object appearing in the standard live view image 300. Accordingly, the user can capture the moving object easily by the first notification information even when the display 121 does not display the second notification information.

Although the examples above have described the cases in which the technique of the present disclosure is applied to mobile phones such as smartphones, the technique of the present disclosure is also applicable to other electronic apparatuses including a plurality of imaging units with different angles of view. For example, the technique of the present disclosure is also applicable to electronic apparatuses such as digital cameras, personal computers, and tablet terminals.

While the electronic apparatus 1 has been described above in detail, the above description is in all aspects illustrative and not restrictive, and the present disclosure is not limited thereto. The various modifications described above are applicable in combination as long as they are not mutually inconsistent. It is understood that numerous modifications which have not been exemplified can be devised without departing from the scope of the present disclosure.

### EXPLANATION OF REFERENCE SIGNS

1 electronic apparatus

2a display screen

100 controller

120 display panel

121 display

180 first imaging unit (standard camera)

180 first imaging range (standard imaging range)

190 second imaging unit (wide-angle camera)

195 second imaging range (wide-angle imaging range)

300 standard live view image

350 wide-angle live view image

360, 362 first marker

370 second marker

500, 510, 520, 521, 530 moving object

1. An electronic apparatus, comprising:
a first camera configured to capture a first imaging range;
a second camera configured to capture a second imaging range having an angle wider than an angle of the first imaging range during a period when the first camera captures the first imaging range;
a display configured to include a display screen and display a first live view image captured by the first camera on the display screen; and
at least one processor, wherein
the at least one processor
detects a position of a moving object moving in the second imaging range based on an image signal from the second camera;
determines whether or not there is the moving object outside the first imaging range and inside the second imaging range based on the position; and
estimates an approach area through which the moving object passes at a time of entering the first imaging range in a periphery of the first imaging range based on the position if the at least one processor determines that there is the moving object outside the first imaging range and inside the second imaging range, and
the display displays first notification information for notifying the approach area on the display screen together with the first live view image.

2. The electronic apparatus according to claim 1, wherein
the at least one processor detects a moving direction of the moving object moving in the second imaging range based on the image signal, and
the at least one processor estimates the approach area based on the position and the moving direction if the at least one processor determines that there is the moving object outside the first imaging range and inside the second imaging range.

3. The electronic apparatus according to claim 1, wherein
the display displays a first marker as the first notification information in a portion corresponding to the approach area in the display screen on which the first live view image is displayed.

4. The electronic apparatus according to claim 1, wherein
the at least one processor determines whether or not there is the moving object inside the first imaging range based on the position, and
the display displays a second notification information for notifying that there is the moving object in the first imaging range on the display screen together with the first live view image if it is determined that there is the moving object inside the first imaging range.

5. The electronic apparatus according to claim 4, wherein
the display displays a second marker, as the second notification information, bordering a portion corresponding to a periphery of the first imaging range in the display screen on which the first live view image is displayed.

6. The electronic apparatus according to claim 1, wherein
the display displays a second live view image captured by the second camera together with the first live view image side by side on the display screen.

7. An operating method of an electronic apparatus including a first camera configured to capture a first imaging range and a second camera configured to capture a second imaging range having an angle wider than an angle of the first imaging range during a period when the first camera captures the first imaging range, comprising:
detecting a position of a moving object moving in the second imaging range based on an image signal from the second camera;
determining whether or not there is the moving object outside the first imaging range and inside the second imaging range based on the position;
estimating an approach area through which the moving object passes at a time of entering the first imaging range in a periphery of the first imaging range based on the position if it is determined that there is the moving object outside the first imaging range and inside the second imaging range; and
displaying notification information for notifying the approach area together with a live view image captured by the first camera.

8. A non-transitory computer-readable recording medium which stores a control program for controlling an electronic apparatus including a first camera configured to capture a first imaging range and a second camera configured to capture a second imaging range having an angle wider than an angle of the first imaging range during a period when the first camera captures the first imaging range, wherein
the control program makes the electronic apparatus execute:
detecting a position of a moving object moving in the second imaging range based on an image signal from the second camera;
determining whether or not there is the moving object outside the first imaging range and inside the second imaging range based on the position;
estimating an approach area through which the moving object passes at a time of entering the first imaging range in a periphery of the first imaging range based on the position if it is determined that there is the moving object outside the first imaging range and inside the second imaging range; and
displaying notification information for notifying the approach area together with a live view image captured by the first camera.
